(19) United States
(12) Patent Application Publication
(10) Pub. No.: US 2004/0152819 A1
(43) Pub. Date: Aug. 5, 2004

(54) Glossy ink jet recording materials

(76) Inventor: Simon R. Cuch, East Longmeadow, MA (US)

Correspondence Address: Mary R. Bonzagni, Esq., Holland & Bonzagni, P.C., 171 Dwight Road, Suite 302, Longmeadow, MA, 01106-1700, US

(21) Appl. No.: 10/752,905

(22) Filed: Jan. 6, 2004

Related U.S. Application Data
(60) Provisional application No. 60/439,245, filed on Jan. 10, 2003.

(51) Int. Cl. B32B 27/00; C08K 3/18; C08K 3/34

(52) U.S. Cl. 524/430; 524/492; 428/423.1

(57) ABSTRACT

A coating formulation for use in preparing a glossy ink jet recording material, and a glossy ink jet recording material prepared thereby, are provided. The glossy ink jet recording material demonstrates gloss levels comparable to that of cast coated papers, in addition to, almost instantaneous drying times, good printability, high printed image waterfastness and lightfastness and high image densities.

### RELATED APPLICATION

This application claims the benefit of U.S. Provisional Patent Application Serial No. 60/439,245, filed Jan. 10, 2003, which is fully incorporated herein by reference.

### FIELD OF THE INVENTION

The present invention basically relates to glossy ink jet recording materials that demonstrate gloss levels comparable to that of cast coated papers, in addition to, almost instantaneous drying times, good printability, high printed image waterfastness and lightfastness and high image densities.

### BACKGROUND OF THE INVENTION

Conventional glossy ink jet recording materials (e.g., ink jet papers for producing near photographic images using Original Equipment Manufacturers (OEM) ink jet printers) are made using polymer-coated base papers. Highly transparent ink jet receptive coatings are typically employed with such papers, rendering the gloss level of such materials dependent upon the gloss level of the underlying polymer-coated base paper.

While demonstrating high gloss and surface uniformity, these papers are expensive to manufacture, have relatively long dry times, and demonstrate poor waterfastness. Ink penetrates the polymeric coating via polymer swelling, which is slow, leaving the printed surface saturated with the ink vehicle. As a result, such materials may show “track marks” or “star wheel” printing defects, which are the result of a partially dried image in direct contact with the printer transport mechanism. In addition, slower dry times may lead to a higher degree of lateral ink spreading, which adversely impacts upon image resolution.

Glossy ink jet recording materials may also be prepared using special coating techniques, such as cast coating. Cast coated materials develop gloss by drying the coatings against a mirror finished drum and are prepared using either a pigmented or a polymeric coating, often with a base paper to provide drainage and curl control. With materials prepared using a pigmented coating, the ink vehicle quickly absorbs into the coating via capillary action and the dry time is short. Cast coated glossy materials prepared using a polymeric coating, however, are slow to dry for the reasons stated in the preceding paragraph. Moreover, both types of cast coated materials suffer from the disadvantage that cast coating is a slow process that requires large capital and operating costs.

A recent attempt at providing a high gloss material that reportedly overcomes the disadvantages associated with cast coated glossy materials is described in EP 1 114 735 A2 (EP '735). This reference discloses a glossy ink jet recording sheet that comprises a paper substrate, a first base coating consisting essentially of precipitated calcium carbonate and calcined clay dispersed in about 10-15% of a binder, and an ink receptive top coating applied over the first base coating consisting essentially of fumed alumina having a primary particle size of about 13 nanometers and a specific surface area of less than about 75 m²/g dispersed in about 5-10% of a binder. The base and ink receptive coatings are applied using conventional coating devices, and the final sheet glossed “by finishing in a super calender device at high moisture (6-8%), at a load of about 600-800 pli, 110-300° F. hot roll temperature, one-to-six nips, at a speed of from 100-450 fpm.” EP '735 at [0025]. The finished coated surface of the recording sheet reportedly has a 60° gloss of at least about 60, when measured in accordance with ASTM Method D523, and a Distinctness of Image (DOI) of at least about 30.

While the glossy ink jet recording sheet of EP '735 reportedly images well on a variety of ink jet printers, such papers do not perform well on all major OEM ink jet printer platforms and do not demonstrate a balance of properties such as high gloss and good imaging performance in combination with good waterfastness and lightfastness. Moreover, attempts to improve the waterfastness of such papers through the use of one or more polycationic materials, such as polydiallyl dimethyl ammonium chloride, adversely impacts upon image densities and/or gloss levels.

A need therefore exists for a glossy ink jet recording material that overcomes the disadvantages of the prior art.

It is therefore a primary object of the present invention to provide such a glossy ink jet recording material.

It is another primary object to provide a novel coating formulation for use in preparing such a recording material.

It is a more particular object to provide an ink jet recording material that demonstrates a gloss level comparable to that of cast coated papers and that can be manufactured using conventional coating methods and techniques with the capability of producing near photographic images using OEM ink jet printers.

It is another more particular object to provide a glossy ink jet recording material that demonstrates almost instantaneous drying times, good printability, high printed image waterfastness and lightfastness and high image densities.

### SUMMARY

The present invention therefore provides a coating formulation for use in preparing a glossy ink jet recording material, which comprises:

(a) from about 75 to about 98% by wt., based on the total dry weight of the coating formulation, of a pigment composition comprising:

(i) from about 0 to about 20% by wt., based on the total dry weight of the pigment composition, of a silica pigment; and

(ii) from about 100 to about 80% by wt., based on the total dry weight of the pigment composition, of fumed metallic oxide particles,

wherein, the sum of the pigment composition components total 100% by dry wt., and

(b) from about 0.5 to about 25% by wt., based on the total dry weight of the coating formulation, of a binder selected from the group of polyurethane, polyester, styrene acrylic and polyvinyl alcohol resins and blends thereof,

wherein, the sum of the coating formulation components total 100% by dry wt., and

wherein the ratio of binder to pigment composition ranges from about 1:100 to about 1:4.

The present invention further provides a glossy ink jet recording material, which comprises:

(a) a substrate having an upper surface and a lower surface,

(b) at least one undercoat ink jet receptive layer located on the upper surface of the substrate, wherein the undercoat layer is prepared using the coating formulation described above,

(c) optionally, at least one overcoat ink jet receptive layer located on the undercoat layer, wherein the overcoat ink jet receptive layer is prepared using a coating formulation comprising:

(i) from about 70 to about 99% by wt., based on the total dry weight of the coating formulation, of a pigment composition comprising:

a. greater than about 20 to about 99% by wt., based on the total dry weight of the pigment composition, of a silica pigment; and

b. less than about 80 to about 1% by wt., based on the total dry weight of the pigment composition, of fumed metallic oxide particles,

wherein, the sum of the pigment composition components total 100% by dry wt., and

(ii) from about 0.5 to about 25% by wt., based on the total dry weight of th coating formulation, of a binder selected from the group of polyurethane, polyester, styrene acrylic and polyvinyl alcohol resins and blends thereof,

wherein, the coating formulation components total 100% by dry wt.,

wherein, the ratio of fumed metallic oxide particles to silica pigment ranges from about 1:100 to about 4:1, and

wherein, the ratio of binder to pigment composition ranges from about 1:200 to about 1:4, and

(d) optionally, one or more anti-curl layers located on the lower surface or backside of the substrate.

Other features and advantages of the invention will be apparent to one of ordinary skill from the following detailed description.

Unless otherwise defined, all technical and scientific terms used herein have the same meaning as commonly understood by one of ordinary skill in the art to which this invention belongs. All publications, patent applications, patents and other references mentioned herein are incorporated by reference in their entirety. In case of conflict, the present specification, including definitions, will control. In addition, the materials, methods, and examples are illustrative only and not intended to be limiting.

### BEST MODE FOR CARRYING OUT THE INVENTION

The ink jet recording material of the present invention is capable of being finished to a high gloss, comparable to that of a cast coated paper, and demonstrates almost instantaneous drying times, good printability, high printed image waterfastness and lightfastness and high image densities. In a preferred embodiment, high image densities are achieved across all major OEM ink jet printer platforms.

By way of the present invention, it has been discovered that the ratio of binder to pigment composition and the ratio of fumed metallic oxide particles to silica pigment used in the undercoat and overcoat ink jet receptive layers of the inventive recording material are instrumental in achieving high gloss and enhanced imaging performance. Furthermore, the use of high levels of silica particles in the overcoat layer has been found not to adversely impact upon gloss levels, as anticipated. It has also been discovered that when the amount of fumed metallic oxide particles in the undercoat layer is higher than the amount present in the overcoat layer, higher gloss levels are achieved by the resulting ink jet recording material. In addition, the present inventor has found that compatibility problems associated with the use of conventional fluorescent optical brighteners may be avoided by the use of select cationic optical brighteners, as detailed below.

The term “gloss” or “high gloss” is used throughout the specification to describe the quality of the coating surface on the substrate defined by its reflection of light. The term “high gloss” refers to a coating after deposition that reads at least about 35° reflection, preferably at least about 45° and most preferably about 55° or higher on a MICRO TRI GLOSS 60° glossmeter.

The substrate or support used to prepare the glossy ink jet recording material of the present invention may be opaque, translucent, or transparent depending upon the intended application.

There is no particular limitation on the kind of substrate. Thus, the substrate includes but is not limited to cellulosic papers, synthetic resin-coated or impregnated papers, emulsion-impregnated papers, rubber latex-impregnated papers, synthetic resin-blended papers, synthetic papers such as polyolefin and polystyrene papers, plastic films such as polyolefin, polyvinyl chloride, polyethylene terephthalate, polystyrene, polymethacrylate, and polycarbonate films, and laminated products of these materials.

The Bekk smoothness of the substrate, as measured in accordance with TAPPI Method No. T-479 cm-99, is at least about 20 sec., preferably at least about 40 sec., and more preferably at least about 60 sec.

Substrates having low surface smoothness may be machine calendered, supercalendered and/or gloss calendered to smooth the substrate surface to the desired level and uniformity.

Smoothing layers may also be employed for this purpose and may be calendered, as described above, prior to applying any additional layers. Suitable compositions for such smoothing layers are known and are generally prepared using organic and/or inorganic pigments (e.g., alumina hydrates, alumina oxides, barium sulfate, calcium carbonate, clays, amorphous silica, silica gel, colloidal silica, styrene acrylic copolymers, talc, titanium dioxide, titanium oxides, zinc oxide and zinc stearate) and one or more binders (e.g., amphoteric latex, casein, cationic starch, cellulose derivatives, ethoxylated starch, carboxy methyl cellulose gum (CMC), hydroxymethyl cellulose, hydroxypropyl cellulose, latex, maleic anhydride resins, melamine resins, modified starch, oxidized starch, polyacrylamide resins, polyester resins, styrene acrylic copolymer resins, polyvinyl acetate, polyvinyl alcohols, polyvinyl pyrrolidone, polyvinyl pyrrolidone vinyl acetate copolymers and water soluble gums). Suitable compositions may further comprise antioxidants, blueing dyes, cationic resins, crosslinkers, defoamers, dispersing agents, optical brighteners, rheology modifiers, slip additives, ultraviolet (UV) absorbers, and wetting agents.

Smoothing layers may also be employed to modify surface pH. The coating formulations of the present invention are acid in nature and after being applied to the surface of the substrate render the coated surface acidic. It has been discovered that the coated surface pH may be rendered substantially neutral by using one or more smoothing layers that have been prepared by a pigment composition comprising, as main ingredients, silica and calcium carbonate pigments. The use of one or more smoothing layers has been found to further enhance the shelf life (when applied to paper substrates), as well as, the printability of the resulting recording material.

In a preferred embodiment of the present invention, the substrate is acid free and is coated with a smoothing layer prepared using a silica/calcium carbonate pigment composition, thereby providing the substrate with a coated surface pH that is substantially neutral and thereby rendering the inventive glossy ink jet recording material acid free.

The thickness of the substrate can be liberally selected according to the intended application, and generally ranges from about 50 to about 400 microns (μ), and more preferably from about 100 to about 250 μ.

The dry basis weight of the substrate can also be liberally selected and generally ranges from about 30 to about 350 grams per square meter (g/m²), and more preferably from about 50 to about 250 g/m².

In a preferred embodiment, the substrate is a cellulosic paper having a Bekk smoothness of at least 40 sec., a thickness ranging from about 100 to about 250 μ, and a dry basis weight ranging from about 50 to about 250 g/m².

In another preferred embodiment, the substrate is a synthetic resin-coated paper also having a Bekk smoothness of at least 40 sec., a thickness ranging from about 100 to about 250 μ, and a dry basis weight ranging from about 50 to about 250 g/m². If desired, in order to improve the adhesion of the undercoat layer to the synthetic resin-coated paper, the surface of the paper may be treated with e.g., corona-discharge, plasma-treatment in a variety of atmospheres, or ultraviolet treatment, or a tie-layer (e.g., a layer prepared using styrene acrylic resins, latex emulsions and/or urethane polymers) may be applied to the paper surface prior to applying the undercoat layer.

The undercoat ink jet receptive layer used to prepare the glossy ink jet recording material of the present invention is prepared using a coating formulation comprising:

(a) from about 75 to about 98% by wt. (preferably from about 80 to about 96% by wt.), based on the total dry weight of the coating formulation, of a pigment composition comprising:

(i) from about 0 to about 20% by wt., based on the total dry weight of the pigment composition, of a silica pigment; and

(ii) from about 100 to about 80% by wt., based on the total dry weight of the pigment composition, of fumed metallic oxide particles,

wherein, the sum of the pigment composition components total 100% by dry wt., and

(b) from about 0.5 to about 25% by wt. (preferably from about 2 to about 15% by wt.), based on the total dry weight of the coating formulation, of a binder selected from the group of polyurethane, polyester, styrene acrylic and polyvinyl alcohol resins and blends thereof,

wherein, the sum of the coating formulation components total 100% by dry wt., and

wherein the ratio of binder to pigment composition ranges from about 1:100 to about 1:4.

Suitable silica pigments for use in the pigment composition include amorphous silicas, colloidal silicas, fumed silicas, precipitated silicas, silica-gel particles and blends thereof. The silica pigments may or may not be aggregated. For aggregated silica pigments, the preferred aggregate size ranges from about 50 to about 600 nanometers (nm).

In a preferred embodiment, the silica pigments are amorphous silicas and/or fumed silicas that have a primary particle size ranging from about 1 to about 300 nm in diameter.

Specific examples of amorphous silicas possessing these physical properties are available from W.R. Grace & Co., 7500 Grace Drive, Columbia, Md. 21044 (“W.R. Grace & Co.”), under the trade designation SYLOJET 4000C, while suitable fumed silicas are available from Cabot Corporation, Two Seaport Lane, Suite 1300, Boston, Mass. 02210-2019 (“Cabot Corporation”), under the trade designation CAB-O-SPERSE PG022.

In another preferred embodiment, the silica pigments are silica-gel particles that have a primary particle size ranging from about 0.05 to about 0.5 μ and an average pore volume ranging from about 0.1 to about 1.0 grams per cubic centimeter (g/cm³).

Specific examples of silica-gel particles possessing these physical properties are available from W.R. Grace & Co., under the trade designation SYLOJET 703C.

Preferably, the silica pigment is present in the pigment composition in an amount ranging from about 1 to about 15% by wt.

Suitable fumed metallic oxide pigments for use in the pigment composition include fumed alumina, titania, antimony(III) oxide, germanium(IV) oxide, tungsten(VI) oxide, and blends thereof. Fumed oxides are available in dry form or as dispersions and may be porous or nonporous.

The fumed metallic oxide particles used in this invention may be in the form of primary particles or in the form of secondary aggregated particles. Preferred aggregates are comprised of smaller primary particles about 1 to about 100 nm in diameter and are aggregated up to about 400 nm in diameter.

In a preferred embodiment, the fumed metallic oxide particles are fumed alumina particles that have a primary particle size ranging from about 1 to about 100 nm (preferably from about 3 to about 50 nm) in diameter and that are aggregated to a size ranging from about 50 to about 400 nm (preferably from about 100 to about 250 nm).

Specific examples of fumed alumina particles possessing these physical properties are available from Cabot Corporation, under the trade designation CAB-O-SPERSE PG003.

Preferably, the fumed metallic oxide particles are present in the pigment composition in an amount ranging from about 85 to about 99% by wt.

It is noted that the use of such small primary and aggregate particle sized fumed metallic oxide particles, especially at the quantities noted, would have been expected by those skilled in the art to produce a more compacted layer with lower macro porosity and thus slower drying times.

The subject pigment composition may contain additional components including, but not limited to, alumina oxide, clay, organic pigments (e.g., melamine benzoguanamine resins, polymethylmethacrylate polymers, styrene acrylic copolymers), talc, and mixtures thereof.

As noted above, the binder is selected from the group of polyurethane, polyester, styrene acrylic and polyvinyl alcohol resins and blends thereof.

The binder may contain additional components including, but not limited to, amphoteric latex, casein, cationic starch, cellulose derivatives, ethoxylated starch, carboxy methyl cellulose gum (CMC), hydroxymethyl cellulose, hydroxypropyl cellulose, latex, maleic anhydride resins, melamine resins, modified starch, oxidized starch, polyacrylamide resins, polyester resins, polyvinyl acetate, modified polyvinyl alcohols, polyvinyl pyrrolidone, polyvinyl pyrrolidone vinyl acetate copolymers, water soluble gums and mixtures thereof.

In a preferred embodiment, the binder is a polyurethane resin and/or a styrene acrylic resin. A preferred polyurethane resin is available from DaiNippon Ink & Chemicals, Inc., DIC Building, 7-20, Nihonbashi 3-chomes, Chuo-ku, Tokyo 103-8233, Japan (“DaiNippon Ink & Chemicals, Inc.”), under the trade designation PATELACOL IJ-55. Preferred styrene acrylic resins are available from Westvaco Corporation, 299 Park Ave., Fla. 12, New York, N.Y. 10171-0399 (“Westvaco Corporation”), under the trade designations DPX 8246-34 and DPX 8389-23.

The binder/pigment composition dry weight ratio in the coating formulation used to prepare the undercoat layer ranges from about 1:100 to about 1:4, preferably ranges from about 1:60 to about 1:7, and more preferably ranges from about 1:40 to about 1:10.

The present inventor has found that if the binder/pigment composition dry weight ratio exceeds 1:4 (i.e., the binder is present in an amount which is greater than 25% of the amount of total pigment), a decrease in gloss or imaging performance will be observed, while if the ratio falls below 1:100 (i.e., the binder is present in an amount which is less than 1% of the amount of total pigment), poor binding strength in the applied coating will be observed.

In addition to the above components, the undercoat coating formulation of the present invention can advantageously contain other additives such as antioxidants, antistatic agents, brightening agents (e.g., fluorescent optical brighteners), crosslinking agents, defoaming agents, dispersing agents, fragrances, mold inhibitors, rheology modifier agents, slip agents, synthetic pigments, UV absorbers, wetting agents, and whitening dyes (e.g., blueing dyes). However, some such additives may adversely impact upon the desirable properties of the resulting undercoat layer.

In a preferred embodiment, the coating formulation also contains from about 1 to about 20% by wt. (more preferably from about 2 to about 10% by wt.), based on the total dry weight of the coating formulation, of a synthetic pigment selected from the group of polyacrylic resins and polystyrene-acrylic resins having a T_{g} of at least 80° C., preferably at least 100° C., and a primary particle size ranging from about 0.05 to about 0.5 μ.

In a more preferred embodiment, the synthetic pigment is cationically charged and serves to complex with anionic dyes to provide enhanced waterfastness. Such pigments may partially replace more expensive pigments such as silicas and fumed aluminas without significantly affecting gloss or imaging performance. In yet a more preferred embodiment, the synthetic pigment is a polyacrylic cationic emulsion polymer available from Specialty Polymers, Inc., 2475 Progress Way, Woodburn, Org. 97071-9768 (“Specialty Polymers, Inc.”), under the trade designation H1Q 078.

In yet another preferred embodiment, the coating formulation also contains from about 0.05 to about 1.0% by wt. (more preferably from about 0.1 to about 0.7% by wt.), based on the total dry weight of the coating formulation, of a fluorescent optical brightener selected from the group of cationic pyrazoline, cationic benzimidazole, benzoxazole derivatives and blends thereof.

By way of the present invention, it was discovered that a majority of the anionically charged and cationically stabilized/anionically charged fluorescent optical brighteners that were tested for use in the coating formulation used to prepare the undercoat layer were incompatible. This observed incompatibility was unexpected where it is fairly common practice in ink jet coating applications to add anionically charged fluorescent optical brighteners (without restriction) at any point during the coating preparation process, preferably prior to adding a cationic resin.

Extensive research has revealed that the coating formulation used to prepare the undercoat layer of the present invention is compatible with select cationic optical brighteners such as cationic pyrazoline. Other suitable cationic optical brighteners include cationic benzimidazole and benzoxazole derivatives.

In view of the above, the coating formulation used to prepare the undercoat layer of the present invention, in a most preferred embodiment, has a cationic charge and comprises:

(a) from about 80 to about 96% by wt., based on the total dry weight of the coating formulation, of a pigment composition comprising:

(i) from about 1 to about 15% by wt., based on the total dry weight of the pigment composition, of one or more amorphous and/or fumed silica pigments; and

(ii) from about 99 to about 85% by wt., based on the total dry weight of the pigment composition, of a fumed alumina pigment,

wherein, the sum of the pigment composition components total 100% by dry wt.,

(b) from about 2 to about 15% by wt., based on the total dry weight of the coating formulation, of a binder selected from the group of polyurethane resins, styrene acrylic resins and blends thereof,

wherein the ratio of binder to pigment composition ranges from about 1:60 to about 1:7,

(c) from about 1 to about 20% by wt., based on the total dry weight of the coating formulation, of a polystyrene-acrylic or polyacrylic synthetic pigment, and

(d) from about 0.05 to about 1.0% by wt., based on the total dry weight of the coating formulation, of a cationic fluorescent optical brightener,

wherein, the coating formulation components total 100% by dry wt.

The undercoat layer coating formulation is made by mixing the components with water so as to obtain an aqueous composition having a solids content ranging from about 10 to about 40% (preferably from about 20 to about 35%), based on the total dry weight of the coating formulation. The pH of the aqueous composition is between 3 and 6, and preferably is between 3.5 and 5.5.

The components used to prepare the aqueous composition are preferably added in the following order: fumed alumina pigment, silica pigment, binder, synthetic pigment, cationic fluorescent optical brightener, dilution water.

The undercoat ink jet receptive coating composition of the present invention is applied so as to achieve a preferred average coat weight that ranges from about 5 to about 40 grams per square meter (gm²), based on the total dry weight of the coating composition. The undercoat coating formulation (as well as the overcoat ink jet recording coating formulation) may be applied using e.g., air knife coaters, rod coaters or gravure coaters. Drying can be accomplished by any known method or technique including room temperature air drying, hot air drying, heating surface-contact drying or heat radiation drying.

In a preferred embodiment, the inventive recording material employs two undercoat layers. In yet a more preferred embodiment, the inventive recording materials employs three undercoat layers.

A second ink jet receptive layer or overcoat layer may be used in conjunction with the undercoat layer(s) when preparing the glossy ink jet recording material of the present invention. The second ink jet receptive layer provides the recording material with the added benefit of being able to provide high density images across all of the major OEM ink jet printer platforms. In addition, the use of the overcoat layer in conjunction with the undercoat layer results in a synergistic increase in image densities and a better balance between gloss and imaging performance. Moreover, and as set forth below, the coating formulation used to prepare the overcoat layer is compatible with cationically stabilized/anionically charged fluorescent whitening agents, which allows for further increases in the brightness and whiteness levels of the inventive recording materials.

The overcoat ink jet receptive layer is prepared using a coating formulation comprising:

(a) from about 70 to about 99% by wt. (preferably from about 80 to about 98% by wt.), based on the total dry weight of the coating formulation, of a pigment composition comprising:

(i) greater than about 20 to about 99% by wt., based on the total dry weight of the pigment composition, of a silica pigment; and

(ii) less than about 80 to about 1% by wt., based on the total dry weight of the pigment composition, of fumed metal oxide particles,

wherein, the sum of the pigment composition components total 100% by dry wt., and

(b) from about 0.5 to about 25% by wt. (preferably from about 1 to about 10% by wt.), based on the total dry weight of the coating formulation, of a binder selected from the group of polyurethane, polyester, styrene acrylic and polyvinyl alcohol resins and blends thereof,

wherein, the sum of the coating formulation components total 100% by dry wt.,

wherein the ratio of fumed metal oxide particles to silica pigment ranges from about 1:100 to about 4:1, and

wherein the ratio of binder to pigment composition ranges from about 1:200 to about 1:4.

Suitable silica pigments and fumed metal oxide particles for use in the overcoat ink jet receptive layer coating formulation are described above in connection with the coating formulation for the undercoat layer.

In a preferred embodiment, the silica pigment is an amorphous silica pigment and is present in the pigment composition in an amount ranging from about 50 to about 98% by wt., based on the total dry weight of the pigment composition, while the fumed metallic oxide particles are fumed alumina particles and are present in the pigment composition in an amount ranging from about 50 to about 2% by wt.

The binder for use in the overcoat ink jet receptive layer coating formulation is the same as that described above in connection with the undercoat layer coating formulation.

In a preferred embodiment, the binder is a polyurethane resin and/or a styrene acrylic resin and is present in the coating formulation in an amount ranging from about 1 to about 10% by dry wt, based on the total dry weight of the coating formulation.

The fumed metallic oxide particles to silica pigment dry weight ratio in the coating formulation used to prepare the overcoat ink jet receptive layer ranges from about 1:100 to about 4:1, preferably ranges from about 1:50 to about 1:1, and more preferably ranges from about 1:40 to about 1:2.

The present inventor has found that if the fumed metallic oxide particles/silica pigment dry weight ratio exceeds 4:1 (i.e., the fumed metallic oxide particles are present in an amount which is greater than about four times the amount of silica pigment), a decrease in imaging performance will be observed, while if the ratio falls below 1:100 (i.e., the fumed metallic oxide particles are present in an amount which is less than 1% of the amount of silica pigment), a decrease in imaging performance or gloss level will be observed.

The binder/pigment composition dry weight ratio in the coating formulation used to prepare the overcoat ink jet receptive layer ranges from about 1:200 to about 1:4, preferably ranges from about 1:100 to about 1:7, and more preferably ranges from about 1:60 to about 1:10.

The present inventor has found that if the binder/pigment composition dry weight ratio exceeds 1:4 (i.e., th binder is present in an amount which is greater than 25% of the amount of total pigment), a decrease in imaging performance or gloss level will be observed, while if the ratio falls below 1:200 (i.e., the binder is present in an amount which is less than 0.5% of the amount of total pigment), poor binding strength in the applied coating will be observed.

The coating formulation used to prepare the overcoat ink jet receptive layer can advantageously contain other additives such as those described above for the undercoat layer coating formulation, provided any such additive does not adversely impact upon the desirable properties of the resulting layer.

In a preferred embodiment, the overcoat coating formulation also contains from about 1 to about 20% by wt. (more preferably from about 2 to about 10% by wt.), based on the total dry weight of the coating formulation, of a synthetic pigment selected from the group of polyacrylic resins and polystyrene-acrylic resins having a T_{g} of at least 80° C., preferably at least 100° C., and a primary particle size ranging from about 0.05 to about 0.5 μ.

In yet another preferred embodiment, the coating formulation also contains from about 0.05 to about 1.0% by wt. (more preferably from about 0.1 to about 0.7% by wt.), based on the total dry weight of the coating formulation, of an optical brightener, preferably a fluorescent optical brightener.

Suitable fluorescent optical brighteners include disulfonated, tetrasulfonated and hexasulfonated stilbene, cationic pyrazoline, cationic benzimidazole, benzoxazole derivatives, and mixtures thereof.

In a preferred embodiment, the optical brightener is a cationic pyrazoline fluorescent optical brightener, which is available from Clariant Corporation, 4000 Monroe Road, Charlotte, N.C. 28205 (“Clariant Corporation”), under the product designation LEUCOPHOR KNR.

Anionic optical brighteners are preferably combined with one or more cationic resins to increase the stability of the optical brightener and to provide a valuable multi-functional agent that combines the activity of both constituents.

Cationic resins capable of stabilizing the optical brighteners include, but are not limited to, polyvinyl benzyl trimethyl ammonium chloride, polydiallyl dimethyl ammonium chloride, polydiallylmethylamine hydrochloride, polydimethyldiallylammonium chloride sulfur dioxide copolymer, polydimethyidiallylammonium chloride acrylamide copolymer, polymethacryloxyethyl hydroxy ethyldiammonium chloride, quaternary acrylic copolymer latex, amidoepichlohydrin copolymer, dimethylaminoethylmethacrylate copolymer, vinyl pyrrolidone dimethylaminoethylmethacrylate copolymer, polyallylamine, polyvinylamine, vinyl amine acrylonitrile copolymers, polyalkylene imine polymers, polyalkylene polyamine polymers, polyalkylene polyamide dicyandiamide copolymers, polyamide dicyandiamide copolymers, quaternary ammonium polymers and blends thereof.

The anionic optical brightener/cationic resin dry weight ratio preferably ranges from about 1:10 to about 2:1, and more preferably ranges from about 1:7 to about 1:1.

In a preferred embodiment, the anionic optical brightener is a hexasulfonated stilbene derivative, which is available from Ciba Specialty Chemical Corp., 540 White Plains Road, Tarrytown, N.Y. 10591 (“Ciba Specialty”), under the product designation TINOPAL ABP-A, while the cationic resin is a polydiallyldimethylammonium chloride resin, which is available from Ciba Specialty, under the trade designation ALCOSTAT 167.

In a most preferred embodiment, the coating formulation used to prepare the overcoat ink jet receptive layer of the present invention has a cationic charge and comprises:

(a) from about 80 to about 98% by wt., based on the total dry weight of the coating formulation, of a pigment composition comprising:

(i) from about 50 to about 98% by wt., based on the total dry weight of the pigment composition, of an amorphous silica pigment; and

(ii) from about 50 to about 2% by wt., based on the total dry weight of the pigment composition, of a fumed alumina pigment,

(b) from about 1 to about 10% by wt., based on the total dry weight of the coating formulation, of a binder selected from the group of polyurethane resins, styrene acrylic copolymers and blends thereof,

wherein the ratio of fumed alumina pigment to amorphous silica pigment ranges from about 1:50 to about 1:1, and

wherein the ratio of binder to pigment composition ranges from about 1:100 to about 1:7; and

(c) from about 1 to about 20% by wt., based on the total dry weight of the coating formulation, of a synthetic pigment selected from the group of polyacrylic resins, polystyrene-acrylic resins and blends thereof, and

(d) from about 0.05 to about 1.0% by wt., based on the total dry weight of the coating formulation, of a polydiallyldimethyl ammonium chloride cationic resin stabilized anionic stilbene fluorescent optical brightener,

wherein the dry weight ratio of anionic stilbene fluorescent optical brightener to cationic resin ranges from about 1:10 to about 2:1, and

wherein, the coating formulation components total 100% by dry wt.

The overcoat ink jet receptive layer coating formulation is made by mixing the components with water so as to obtain an aqueous composition having a solids content ranging from about 10 to about 40% (preferably from about 20 to about 35%), based on the total dry weight of the coating formulation. The pH of the aqueous composition is between 3.0 and 6.0, and preferably is between 3.5 and 5.5.

The components used to prepare the aqueous composition are preferably added in the following order: silica pigment, fumed alumina pigment, binder, synthetic pigment, cationic fluorescent optical brightener, dilution water.

The overcoat ink jet receptive coating composition of the present invention is applied so as to achieve a preferred average coat weight that ranges from about 5 to about 30 g/m², based on the total dry weight of the coating composition.

One or more anti-curl layers may be used with the ink jet recording material of the present invention. As is well known to those skilled in the art, curling of ink jet recording materials may be reduced or eliminated by the addition of a coating to the backside of the substrate or support material. The coating is applied to counteract any shrinkage or swelling resulting from the ink jet receiving layers. Suitable compositions for such anti-curl layers are known and generally include a binder (e.g., polyvinyl alcohol) or a pigment/binder blend, and optionally other additives such as antioxidants, antistatic agents, cationic resins, crosslinking agents, defoaming agents, dispersing agents (e.g., acrylic acid copolymer salts), fragrances, inorganic dyestuffs, mold inhibitors, organic dyestuffs, slip agents, surfactants (e.g., octyl phenoxy ethanol), UV absorbers, wetting agents and fluorescent whitening agents.

The inventive ink jet recording material may be glossed by finishing in a calendering device using conventional calendering conditions. It is important to note that supercalendering conditions are not required to achieve the high gloss levels demonstrated by the ink jet recording material of the present invention. For glossy ink jet recording materials employing substrates having low surface smoothness, the material is preferably calendered after the undercoat layer has been applied to the substrate. For glossy ink jet recording materials employing substrates having relatively smooth surfaces, the material is preferably calendered after the undercoat and overcoat layers have been applied.

A number of different layer constructions for the glossy ink jet recording material of the present invention are contemplated, several of which are identified below:

(a) substrate/undercoat ink jet receptive layer (“undercoat layer”)/overcoat ink jet receptive layer (“overcoat layer”);

(b) substrate/undercoat layer/undercoat layer/overcoat layer;

(c) substrate/undercoat layer/undercoat layer/undercoat layer/overcoat layer; and

(d) substrate/undercoat layer/overcoat layer/undercoat layer/overcoat layer.

As noted above, the ink jet recording material of the present invention has a gloss level comparable to that of cast coated papers. More specifically, gloss levels of at least about 35° reflection (when read on a MICRO-TRI-GLOSS 60° glossmeter) may be achieved by the inventive ink jet recording material.

Almost instantaneous drying times are also realized by the inventive recording material, which is evidenced by the lack of star wheel marks on the printed surface of these materials. As will be described in more detail below, star wheels are part of the feeding mechanism of OEM ink jet printers, which allow the media to be transported through the printer. These star-shaped wheels are in contact with the media on the printed side just after the media is imaged. If the ink has not dried, or if the printed image is still tacky, track marks will be left on the printed areas.

Under magnification, the inventive glossy ink jet recording material has a so-called cracked-mud appearance, which may contribute to the almost instantaneous drying times demonstrated by the inventive material. It is noted that those skilled in the art may view this as disadvantageous, where coatings exhibiting discontinuities or defects such as cracking, repellencies, comb lines and the like are viewed as surface defects that affect the coating uniformity and glossy characteristics.

In addition to the gloss levels and instantaneous drying times noted above, the inventive recording material also demonstrates good printability, high printed image waterfastness and lightfastness and high image densities. In a preferred embodiment, high image densities are achieved across all major OEM ink jet printer platforms.

The subject invention will now be described by reference to the following illustrative examples.

### WORKING EXAMPLES

### Components Used

In the Working Examples set forth below, the following components and materials were used:

| | |
|---|---|
| SILICA I | a cationically charged amorphous synthetic silica dispersion at |
| | 40% solids having a pH of 4 and a surface area of about 75 m²/g, |
| | supplied by W.R. Grace & Co. under the trade designation |
| | SYLOJET 4000 C. |
| SILICA II | a cationically charged silica gel dispersion at 30% solids having a |
| | pore volume of 0.8 cc/g and an average particle size of 0.3 |
| | microns, supplied by W.R. Grace & Co. under the trade |
| | designation SYLOJET 703 C. |
| SILICA III | a cationically charged fumed silica dispersion at 20% solids |
| | having an average primary particle size diameter of 15 nm and a |
| | median aggregate diameter of 200 nm, supplied by Cabot |
| | Corporation under the trade designation CAB-O-SPERSE PG022. |
| FUMED | a cationically charged fumed alumina dispersion at 40% solids |
| ALUMINA | having an average primary particle size diameter of 20 nm and a |
| | median aggregate diameter of 160 nm, supplied by Cabot |
| | Corporation under the trade designation Cab-O-Sperse PG003. |
| CATIONIC | a cationic acrylic copolymer water based emulsion, supplied at 40% |
| LATEX | solids, having a T_{g} of −21° C., marketed by Westvaco Corporation, |
| | under the trade designation DPX 8246-34. |
| CATIONIC | a cationic styrene-acrylic copolymer water based emulsion, supplied |
| LATEX II | at 40% solids, having a T_{g} of 23° C., marketed by Westvaco |
| | Corporation, under the trade designation DPX 8389-23. |
| CATIONIC | a cationic styrene-acrylic copolymer water based emulsion, supplied |
| LATEX III | at 41% solids, having a T_{g} of 114° C., marketed by Specialty Polymers, |
| | Inc., under the trade designation H1Q 078. |
| POLYURETHANE | a modified polyurethane water based emulsion, supplied at 15% |
| RESIN | solids, marketed by DaiNippon Ink & Chemicals, Inc., under the trade |
| | designation PATELACOL IJ-55. |
| POLYURETHANE | a modified polyurethane water based emulsion, supplied at 15% |
| RESIN II | solids, marketed by Esprix Technologies, 7680 Matoaka Road, |
| | Sarasota, FL 34243, under the trade designation ESPRIT INK JET |
| | EMULSION IJ-80. |
| FWA I | a stilbene fluorescent whitening agent marketed by Ciba Specialty, |
| | supplied as a water based solution at 29% solids, under the trade |
| | designation TINOPAL ABP-A. |
| FWA II | a cationic pyrazoline derivative fluorescent whitening agent, supplied |
| | as a water-based solution at 15% solids, by Clariant Corporation, |
| | under the trade designation LEUCOPHOR KNR liquid. |
| BLUEING | a water-based blueing pigment dye marketed by Ciba Specialty, under |
| DYE I | the trade designation IRGALITE BLUE RL. |
| BLUEING | a water-based blueing pigment dye marketed by Bayer Industrial |
| DYE II | Chemicals, 100 Bayer Road, Pittsburgh, PA 15205, under the trade |
| | designation PONOLITH RED WC. |
| WETTING | an ethoxylated acetylenic diol surfactant marketed by Air Products and |
| AGENT | Chemicals, Inc., 7201 Hamilton Boulevard, Allentown, PA 18195- |
| | 1501, under the trade designation SURFYNOL 465. |
| CATIONIC | a quaternary ammonium polymer (poly(dimethyldiallylammonium |
| RESIN | chloride)), supplied as a water based solution at 30% solids, marketed |
| | by Ciba Specialty under the trade designation ALCOSTAT 167. |
| BP-1 | a base paper having a basis weight of 150 g/m² and a Bekk |
| | smoothness of 65 sold by Domtar Industries, 55 Park Place, Atlanta, |
| | GA 30303, under the trade designation 102# White Tag. |
| BP-2 | a wood free base paper having a basis weight of 120 g/m², a Cobb |
| | sizing of less than 80 and a Bekk smoothness of 22 sold by Blue |
| | Ridge Paper Products Inc., 34 Park Street, Canton, NC 28716, under |
| | the trade designation INK081WHI. |
| BP-3 | BP-2 calendared at 400 PLI to achieve a Bekk smoothness of 43. |

### Test Methods

Ink jet recording materials, prepared as set forth hereinbelow, were subjected to several evaluation tests. HP 940c, EPSON 888 and EPSON 1270 narrow format printers and HP-2500 CP wide format printer manufactured by Hewlett Packard Co.,and Seiko Epson Corporation, were used in conjunction with these tests. The printers were used to print images on the ink jet recording materials using seven colors.

A test target, for each color tested, was made using CORELDRAW 9 software, manufactured by Corel Corporation, 1600 Carling Avenue, Ottawa, Ontario, Canada. The color properties were defined by applying a CMYK model (i.e., the test print to measure optical densities defined each color as follows: Black (K:100), Magenta (M:100), Red (M:100, Y:100), Yellow (Y:100), Purple (M:100, C:100), Green (C:100, Y:100) and Cyan (C:100)).

The target was printed directly from CORELDRAW 9 to the following printers; HP 940c (Printer Settings; Paper type: Photo/Glossy papers-HP premium photo paper, Print quality: Best); EPSON 888 (Printer Settings: Media type: Photo Quality Glossy Film); EPSON 1270 (Printer Settings Media type: Photo Quality Glossy Film).

For the HP 2500cp wide format printer, the test target was imported into POSTERSHOP software manufactured by Onyx Graphics Corp., 6915 South High Tech Drive, Midvale, Utah and printed as per the following settings: coated paper mode, HP dye ink, eight pass quality (enhanced) varware mode, bi-directional, stochastic dot pattern (600 dpi), prior to printing images on the coated papers.

### Image Density

Image density is basically a measurement of the amount of light reflected by a sample. Image density is referred to as either optical density, color density or image density. Black, magenta, red, yellow, purple, green and cyan color densities were measured with an X-RITE 418 color densitometer, which is sold by X-Rite Corporation, 3100 44th Street Southwest, Grandville, Mich. 49418. Generally, in this test, a higher image density value denotes a higher strength of the measured color. A low image density may indicate either excessive dot gain control or penetration of the inks into the substrate. The sum of each individual density, for a given sample and printer, is referred hereinbelow as “Sum of Image Densities”; higher values indicate, in general, a higher density in one or more of the colors tested.

### Lightfastness (Background Light Stability)

Lightfastness refers to the durability or fade resistance of a coated paper when exposed to ultraviolet light. For this test, the coated test specimens and the Commercial Papers were tested for brightness and whiteness using a TECHNIBRITE MICRO TD 1C brightness meter, which is sold by Technidyne Corporation, 100 Quality Avenue, New Albany, N.Y. 47150, and the values recorded. L,a,b values were also determined and recorded. L,a,b values constitute a series of coordinates obtained from a colorimeter which describe any color as a set of three values. The “L” coordinate designates a value from light to dark, the “a” coordinate designates a value from red to green and the “b” coordinate designates a value from blue to yellow. These three numbers position any color in the 3 axis area and allows a comparison to be made to match any particular color standard.

The coated test specimens and the Commercial Papers were then exposed to ultraviolet light (irradiance=0.35 W/m² at 340 nanometers) for 15 hours using an ATLAS fadeometer, model no. CI 3000, which is sold by Atlas Electric Devices Company, 4114 North Ravenswood Avenue, Chicago, Ill. 60613, and brightness, whiteness and L,a,b values remeasured and recorded for each exposed sample.

ΔE values were then determined using the following equation:

ΔE=(Lᵢₙᵢₜᵢₐₗ−L_{uv exposed})²+(aᵢₙᵢₜᵢₐₗ−a_{uv exposed})²+(bᵢₙᵢₜᵢₐₗ−b_{uv exposed})²)^{0.5}

In general, the lower the ΔE value, the better the background light stability. High brightness and whiteness as well as low ΔE values are preferred.

Percent lightfastness was calculated by first dividing the image densities after lightfastness testing by the image densities prior to testing, then multiplying each result by 100, for each color tested, and finally averaging the results.

### Waterfastness

Waterfastness refers to the resistance of an ink jet image to dilution or removal by water. In a waterfast, coated paper, inks have a reduced tendency to wick or feather. The coated test specimens and the Commercial Papers were tested for waterfastness by (1) printing each test specimen and Commercial Paper with either HP 940c or Epson 888 printer, (2) measuring and recording the image densities of each color (i.e., black, magenta, red, yellow, purple, green and cyan) imaged on the printed samples, (3) immersing each printed sample in tap water for five minutes, (4) removing excess water from each sample using a paper towel, (5) drying each sample by placing the sample in a convection oven set at 110° C. for three minutes, (6) allowing each sample to cool down and equilibrate to room temperature, and (7) remeasuring color densities for each printed test specimen and Commercial Paper.

Percent waterfastness was calculated by first dividing the image densities after waterfastness testing by the image densities prior to testing, then multiplying each result by 100, for each color tested, and finally averaging the results.

### Visual Waterfastness

Visual Waterfastness (V) refers to the visual appearance of the printed area of the ink jet recording material after waterfastness testing. Visual appearance was rated as follows:

| Rating | Visual Waterfastness (V) |
|---|---|
| Very Good (VG) | minimal to no ink diffusion, little or no visual changes |
| | in image densities. |
| Good (G) | low ink diffusion, little or no visual changes in image |
| | densities. |
| Fair (F) | moderate ink diffusion, little or no visual change in |
| | image densities. |
| Poor (P) | clear reduction in image densities or coating structure |
| | significantly affected. |

### Imaged Area Uniformity

The visual uniformity of the printed areas of each test sample were evaluated and rated as set forth below:

| Rating | Imaged Area Uniformity |
|---|---|
| Good (G) | uniform printed areas and uniform gloss |
| Fair (F) | minor non-uniformity and/or printed colors had |
| | a dull gloss level when compared to the gloss |
| | level of unprinted areas. |
| Poor (P) | non-uniformity in printed areas and/or dull gloss |
| | level in two or more printed areas. |

### Star Wheel Defect

Star wheels are part of the feeding mechanism of OEM ink jet printers, which allow the media to be transported through the printer. These star-shaped wheels are in contact with the media on the printed side just after the media is imaged. If the ink has not dried, or if the printed image is still tacky, track marks will be left on the printed areas. When the problem is severe enough, wet ink may be transferred by the wheels to other printed or unprinted portions of the media. The visual appearance of the portions of imaged test samples that have contacted star wheels was rated as follows:

| Rating | Star Wheel Defect |
|---|---|
| Very Good (VG) | no star wheel marks were seen on the printed surface |
| Good (G) | minor star wheel marks were left in the printed area |
| Fair (F) | faint star wheel marks were seen as well as the loss of |
| | a minor amount of ink from the printed surface. |
| Poor (P) | severe star wheel marks were seen on the printed |
| | surface. |

### Visual Gloss

Visual gloss refers to the uniformity of gloss apparent to the naked eye on a surface of the test sample. Visual gloss was rated as follows:

| Rating | Visual Gloss |
|---|---|
| Good (G) | fairly uniform gloss level on surface of test sample |
| Fair (F) | minor blotchy or spotted appearance on surface |
| | of test sample. |
| Poor (P) | non-uniform gloss level on surface of test sample |

### Gloss at 60° and 85°

Surface gloss was measured at reflected light angles of 60° and 85° using a MICRO-TRI-GLOSS meter manufactured by BYK-Gardner USA, RiversPark II, 9104 Guilford Road, Columbia, Md. 21046. This instrument, which conforms to the following standards: DIN 67 530, ISO 2813, ASTM D523 and BS 3900 Part D5, directed light beams toward the surface of each test sample at 60° and 85° angles and photoelectrically measured the light reflected from the surface. Gloss levels were classified as set forth below:

| Rating | Gloss at 60° or at 85° |
|---|---|
| Matte | <10 |
| Semi-Gloss | between 10 and 70 |
| High Gloss | >70 |

### Part A

### Sample Preparation

The aqueous coating formulations described below in Table A were used to form undercoat layers on BP-1 base papers by (1) applying the coating formulation to the base paper to form a first undercoat layer having a coating weight of about 11 g/m², (2) drying the first undercoat layer, (3) applying the coating formulation to the first undercoat layer to form a second undercoat layer having a coating weight of about 14 g/m², and (4) drying the second undercoat layer.

TABLE A
Coating Formulations For Undercoat Ink Jet Receptive Layer

| | Undercoat Ink Jet | | | | | |
|---|---|---|---|---|---|---|
| Components¹ (parts | Receptive Layer | | | | | |
| per weight) | U-1 | U-2 | U-3 | U-4 | U-5 | U-6 |
| FUMED | 200 | 220 | 225 | 230 | 225 | 210 |
| ALUMINA | | | | | | |
| SILICA I | — | 10 | — | — | 10 | 10 |
| CATIONIC | 8 | 5.33 | — | — | 5.33 | — |
| LATEX I | | | | | | |
| CATIONIC | — | — | — | 5 | 5 | 5 |
| LATEX II | | | | | | |
| CATIONIC | 18.2 | 4.85 | 14.56 | 4.85 | 4.85 | 14.56 |
| LATEX III | | | | | | |
| POLYURETHANE | 20 | — | — | — | — | — |
| RESIN I | | | | | | |
| POLYURETHANE | — | 26.67 | 26.67 | 26.67 | 13.3 | 26.67 |
| RESIN II | | | | | | |
| BLUEING DYE I² | 0.42 | 0.42 | 0.42 | 0.42 | 0.42 | 0.42 |
| BLUEING DYE I³ | 1.20 | 1.20 | 1.20 | 1.20 | 1.20 | 1.20 |
| WETTING | 0.60 | 0.60 | 0.60 | 0.60 | 0.60 | 0.60 |
| AGENT⁴ | | | | | | |
| WATER | 26.8 | 8.88 | 9.51 | 9.22 | 17.8 | 9.51 |
| % SOLIDS | 34 | 36 | 36 | 36 | 36 | 36 |
| BINDER-TO- | 1:13 | 1:15 | 1:23 | 1:15 | 1:16 | 1:15 |
| PIGMENT RATIO⁵ | | | | | | |

¹Parts added, as supplied, unless otherwise specified.
²Supplied at a 24.9% solids, diluted 1:100 with water prior to using.
³Supplied at a 20.5% solids, diluted 1:100 with water prior to using.
⁴Diluted 1:10 with water prior to using.
⁵Dry Basis

The aqueous coating formulations described below in Table B were then applied to each coated base paper to form an outercoat ink jet receptive layer having a coating weight of about 14 g/m².

TABLE B
Coating Formulations For Overcoat Ink Jet Receptive Layer

| Components¹ | Overcoat Ink Jet Receptive Layer | | | | | | | | |
|---|---|---|---|---|---|---|---|---|---|
| (parts per weight) | I | II | III | IV | V | VI | VII | VIII | IX |
| SILICA I | 87.50 | 105 | 105 | 105 | 95 | 102.5 | 105 | 91.25 | 88.75 |
| SILICA II | 1.25 | 1.67 | — | 1.67 | 1.67 | 1.67 | — | — | — |
| SILICA III | 3.13 | 5.0 | — | — | 7.5 | — | 7.5 | 7.5 | 7.5 |
| FUMED | 17.5 | 6.25 | 17.5 | 8.75 | 18.75 | 18.75 | 10 | 18.75 | 18.75 |
| ALUMINA | | | | | | | | | |
| CATIONIC | — | — | 2.5 | 2.5 | — | 2.5 | — | 2.5 | 2.5 |
| LATEX II | | | | | | | | | |
| CATIONIC | 1.82 | 4.85 | — | 4.85 | — | — | — | 4.85 | 4.85 |
| LATEX III | | | | | | | | | |
| POLYURETHANE | 6.67 | — | — | — | — | — | — | — | — |
| RESIN I | | | | | | | | | |
| POLYURETHANE | — | 6.67 | — | 6.67 | 6.67 | — | 6.67 | — | 6.67 |
| RESIN II | | | | | | | | | |
| WETTING | 0.30 | 0.30 | 0.30 | 0.30 | 0.30 | 0.30 | 0.30 | 0.30 | 0.30 |
| AGENT² | | | | | | | | | |
| WATER | 4.5 | 6.5 | 13.7 | 9.2 | 4.9 | 13.3 | 5.3 | 9.7 | 5.5 |
| % SOLIDS | 36 | 36 | 36 | 36 | 36 | 36 | 36 | 36 | 36 |
| ALUMINA-TO- | 1:5 | 1:17 | 1:6 | 1:12 | 1:5 | 1:6 | 1:11 | 1:5 | 1:5 |
| SILICA RATIO³ | | | | | | | | | |
| BINDER-TO- | 1:43 | 1:46 | 1:49 | 1:23 | 1:48 | 1:49 | 1:48 | 1:46 | 1:22 |
| PIGMENT | | | | | | | | | |
| RATIO³ | | | | | | | | | |

¹Parts added, as supplied, unless otherwise specified.
²Diluted 1:10 with water prior to using.
³Dry Basis

The coated base papers were then calendered using a one nip, two roll calendering device. The first roll of the calendering device was a steel roll with a chrome-finished surface, while the second roll was a wool roll having a Schmidth Hammer hardness of 40. The coated base papers were passed through the calendering nip at a pressure of 800 PLI and at a speed of 21 feet per minute. The first and second rolls of the calendering device were kept at room temperature.

### EXAMPLES 1 to 44

In these examples, the test samples described above were imaged using HP-940c, EPSON 888 and EPSON 1270 narrow format ink jet printers and the image densities of the formed images measured and recorded. The results are set forth in Table 1, hereinbelow.

TABLE 1
Summary of Examples 1 to 9

| | Example | | | | | | | | |
|---|---|---|---|---|---|---|---|---|---|
| | 1 | 2 | 3 | 4 | 5 | 6 | 7 | 8 | 9 |
| Undercoat Ink | U-1 | U-1 | U-1 | U-1 | U-1 | U-1 | U-1 | U-1 | U-1 |
| Jet Receptive Layer | | | | | | | | | |
| Overcoat Ink | I | II | III | IV | V | VI | VII | VIII | IX |
| Jet Receptive Layer | | | | | | | | | |

Image Densities

| | | | | | | | | | |
|---|---|---|---|---|---|---|---|---|---|
| HP-940C | | | | | | | | | |
| Black | 2.12 | 2.10 | 2.27 | 2.06 | 2.13 | 2.33 | 2.13 | 2.02 | 1.81 |
| Magenta | 2.03 | 2.04 | 2.15 | 1.92 | 2.01 | 2.12 | 2.03 | 1.93 | 1.77 |
| Red | 1.63 | 1.62 | 1.68 | 1.56 | 1.62 | 1.65 | 1.64 | 1.57 | 1.46 |
| Yellow | 1.22 | 1.23 | 1.28 | 1.21 | 1.22 | 1.26 | 1.23 | 1.20 | 1.14 |
| Purple | 2.25 | 2.22 | 2.43 | 1.99 | 2.28 | 2.34 | 2.27 | 2.14 | 1.99 |
| Green | 1.32 | 1.33 | 1.38 | 1.25 | 1.34 | 1.36 | 1.35 | 1.36 | 1.29 |
| Cyan | 1.15 | 1.11 | 1.21 | 1.08 | 1.20 | 1.19 | 1.18 | 1.17 | 1.12 |
| EPSON 888 | | | | | | | | | |
| Black | 2.46 | 2.42 | 2.49 | 2.14 | 2.47 | 2.53 | 2.54 | 2.29 | 2.00 |
| Magenta | 1.88 | 1.91 | 1.84 | 1.71 | 1.88 | 1.89 | 1.93 | 1.73 | 1.58 |
| Red | 1.85 | 1.91 | 1.77 | 1.74 | 1.85 | 1.92 | 1.91 | 1.70 | 1.55 |
| Yellow | 1.32 | 1.33 | 1.30 | 1.25 | 1.42 | 1.30 | 1.32 | 1.28 | 1.19 |
| Purple | 2.38 | 2.28 | 2.49 | 1.97 | 2.31 | 2.54 | 2.47 | 2.30 | 1.98 |
| Green | 2.05 | 1.98 | 2.17 | 1.72 | 2.16 | 2.17 | 2.17 | 2.06 | 1.82 |
| Cyan | 2.22 | 2.06 | 2.42 | 1.85 | 2.34 | 2.34 | 2.27 | 2.35 | 1.97 |
| EPSON 1270 | | | | | | | | | |
| Black | 2.24 | 2.36 | 2.48 | 2.09 | 2.40 | 2.50 | 2.46 | 2.27 | 1.99 |
| Magenta | 1.74 | 1.74 | 1.75 | 1.57 | 1.76 | 1.76 | 1.79 | 1.68 | 1.52 |
| Red | 1.72 | 1.71 | 1.70 | 1.56 | 1.73 | 1.73 | 1.77 | 1.64 | 1.48 |
| Yellow | 1.01 | 1.00 | 1.03 | 0.97 | 1.02 | 1.04 | 1.03 | 1.05 | 1.00 |
| Purple | 1.50 | 1.37 | 1.51 | 1.28 | 1.75 | 1.53 | 1.62 | 1.88 | 1.44 |
| Green | 1.44 | 1.39 | 1.52 | 1.33 | 1.60 | 1.51 | 1.56 | 1.77 | 1.42 |
| Cyan | 1.70 | 1.62 | 1.77 | 1.52 | 1.84 | 1.75 | 1.74 | 1.84 | 1.69 |

Summary of Examples 10 to 16

| | Example | | | | | | |
|---|---|---|---|---|---|---|---|
| | 10 | 11 | 12 | 13 | 14 | 15 | 16 |
| Undercoat Ink | U-2 | U-2 | U-2 | U-2 | U-2 | U-2 | U-2 |
| Jet Receptive | | | | | | | |
| Layer | | | | | | | |
| Overcoat Ink | I | II | III | IV | V | VI | VII |
| Jet Receptive | | | | | | | |
| Layer | | | | | | | |

Image Densities

| | | | | | | | |
|---|---|---|---|---|---|---|---|
| HP-940C | | | | | | | |
| Black | 2.09 | 2.17 | 2.33 | 2.14 | 2.06 | 2.32 | 2.11 |
| Magenta | 2.01 | 2.06 | 2.11 | 1.96 | 1.96 | 2.12 | 2.01 |
| Red | 1.6 | 1.64 | 1.66 | 1.58 | 1.59 | 1.66 | 1.64 |
| Yellow | 1.22 | 1.24 | 1.27 | 1.22 | 1.21 | 1.27 | 1.22 |
| Purple | 2.17 | 2.23 | 2.38 | 2.09 | 2.27 | 2.39 | 2.24 |
| Green | 1.30 | 1.31 | 1.36 | 1.27 | 1.34 | 1.37 | 1.35 |
| Cyan | 1.12 | 1.10 | 1.16 | 1.07 | 1.19 | 1.18 | 1.18 |
| EPSON 888 | | | | | | | |
| Black | 2.44 | 2.22 | 2.56 | 2.13 | 2.48 | 2.54 | 2.53 |
| Magenta | 1.89 | 1.88 | 1.86 | 1.65 | 1.89 | 1.83 | 1.91 |
| Red | 1.84 | 1.83 | 1.78 | 1.63 | 1.83 | 1.77 | 1.86 |
| Yellow | 1.35 | 1.34 | 1.34 | 1.27 | 1.35 | 1.33 | 1.36 |
| Purple | 2.33 | 2.31 | 2.51 | 2.02 | 2.41 | 2.51 | 2.35 |
| Green | 2.04 | 2.01 | 2.22 | 1.74 | 2.16 | 2.23 | 2.17 |
| Cyan | 2.10 | 2.08 | 2.51 | 1.88 | 2.36 | 2.52 | 2.32 |
| EPSON 1270 | | | | | | | |
| Black | 2.36 | 2.38 | 2.56 | 2.08 | 2.43 | 2.56 | 2.53 |
| Magenta | 1.77 | 1.77 | 1.78 | 1.56 | 1.78 | 1.84 | 1.88 |
| Red | 1.75 | 1.74 | 1.74 | 1.54 | 1.74 | 1.75 | 1.84 |
| Yellow | 0.99 | 1.00 | 1.03 | 0.97 | 1.02 | 1.24 | 1.25 |
| Purple | 1.50 | 1.43 | 1.70 | 1.34 | 1.82 | 1.97 | 1.98 |
| Green | 1.48 | 1.42 | 1.71 | 1.36 | 1.66 | 1.79 | 1.74 |
| Cyan | 1.70 | 1.67 | 1.85 | 1.56 | 1.91 | 2.00 | 2.04 |

Summary of Examples 17 to 23

| | Example | | | | | | |
|---|---|---|---|---|---|---|---|
| | 17 | 18 | 19 | 13 | 14 | 15 | 23 |
| Undercoat Ink | U-3 | U-3 | U-3 | U-3 | U-3 | U-3 | U-3 |
| Jet Receptive | | | | | | | |
| Layer | | | | | | | |
| Overcoat Ink | I | II | III | IV | V | VI | VII |
| Jet Receptive | | | | | | | |
| Layer | | | | | | | |

Image Densities

| | | | | | | | |
|---|---|---|---|---|---|---|---|
| HP-940C | | | | | | | |
| Black | 2.15 | 2.14 | 2.36 | 2.13 | 2.06 | 2.37 | 2.14 |
| Magenta | 2.03 | 2.02 | 2.15 | 1.95 | 1.95 | 2.14 | 2.05 |
| Red | 1.64 | 1.65 | 1.71 | 1.59 | 1.59 | 1.71 | 1.65 |
| Yellow | 1.22 | 1.23 | 1.28 | 1.21 | 1.20 | 1.28 | 1.22 |
| Purple | 2.23 | 2.24 | 2.43 | 2.11 | 2.25 | 2.42 | 2.25 |
| Green | 1.31 | 1.30 | 1.37 | 1.27 | 1.34 | 1.36 | 1.32 |
| Cyan | 1.14 | 1.09 | 1.18 | 1.08 | 1.18 | 1.18 | 1.17 |
| EPSON 888 | | | | | | | |
| Black | 2.39 | 2.43 | 2.49 | 2.15 | 2.48 | 2.57 | 2.58 |
| Magenta | 1.84 | 1.87 | 1.84 | 1.67 | 1.87 | 1.83 | 1.90 |
| Red | 1.82 | 1.85 | 1.85 | 1.68 | 1.82 | 1.84 | 1.88 |
| Yellow | 1.31 | 1.32 | 1.30 | 1.25 | 1.32 | 1.30 | 1.33 |
| Purple | 2.33 | 2.34 | 2.51 | 2.11 | 2.40 | 2.53 | 2.48 |
| Green | 2.08 | 2.07 | 2.22 | 1.84 | 2.13 | 2.20 | 2.15 |
| Cyan | 2.17 | 2.15 | 2.47 | 1.95 | 2.36 | 2.44 | 2.34 |
| EPSON 1270 | | | | | | | |
| Black | 2.27 | 2.37 | 2.56 | 2.09 | 2.28 | 2.49 | 2.45 |
| Magenta | 1.74 | 1.74 | 1.76 | 1.58 | 1.76 | 1.76 | 1.79 |
| Red | 1.70 | 1.74 | 1.73 | 1.56 | 1.73 | 1.73 | 1.78 |
| Yellow | 1.00 | 1.00 | 1.04 | 0.97 | 1.04 | 1.04 | 1.03 |
| Purple | 1.57 | 1.51 | 1.80 | 1.39 | 1.86 | 1.85 | 1.74 |
| Green | 1.52 | 1.48 | 1.75 | 1.38 | 1.71 | 1.76 | 1.64 |
| Cyan | 1.74 | 1.68 | 1.88 | 1.57 | 1.92 | 1.88 | 1.83 |

Summary of Examples 24 to 30

| | Example | | | | | | |
|---|---|---|---|---|---|---|---|
| | 24 | 25 | 26 | 27 | 28 | 15 | 30 |
| Undercoat Ink | U-4 | U-4 | U-4 | U-4 | U-4 | U-4 | U-4 |
| Jet Receptive | | | | | | | |
| Layer | | | | | | | |
| Overcoat Ink | I | II | III | IV | V | VI | VII |
| Jet Receptive | | | | | | | |
| Layer | | | | | | | |

Image Densities

| | | | | | | | |
|---|---|---|---|---|---|---|---|
| HP-940C | | | | | | | |
| Black | 2.03 | 2.14 | 2.34 | 2.11 | 2.07 | 2.35 | 2.11 |
| Magenta | 1.97 | 2.03 | 2.14 | 1.97 | 1.99 | 2.13 | 2.05 |
| Red | 1.60 | 1.63 | 1.67 | 1.59 | 1.61 | 1.67 | 1.63 |
| Yellow | 1.21 | 1.22 | 1.26 | 1.21 | 1.21 | 1.26 | 1.21 |
| Purple | 2.17 | 2.20 | 2.37 | 2.10 | 2.26 | 2.40 | 2.26 |
| Green | 1.31 | 1.29 | 1.34 | 1.26 | 1.35 | 1.36 | 1.33 |
| Cyan | 1.13 | 1.10 | 1.16 | 1.07 | 1.19 | 1.18 | 1.18 |
| EPSON 888 | | | | | | | |
| Black | 2.41 | 2.35 | 2.57 | 2.13 | 2.47 | 2.56 | 2.55 |
| Magenta | 1.84 | 1.85 | 1.82 | 1.67 | 1.85 | 1.83 | 1.90 |
| Red | 1.81 | 1.85 | 1.83 | 1.69 | 1.82 | 1.85 | 1.84 |
| Yellow | 1.31 | 1.31 | 1.30 | 1.24 | 1.31 | 1.30 | 1.33 |
| Purple | 2.29 | 2.31 | 2.54 | 2.08 | 2.40 | 2.59 | 2.50 |
| Green | 2.06 | 2.01 | 2.23 | 1.82 | 2.14 | 2.24 | 2.17 |
| Cyan | 2.18 | 2.10 | 2.45 | 1.91 | 2.38 | 2.47 | 2.36 |
| EPSON 1270 | | | | | | | |
| Black | 2.31 | 2.31 | 2.48 | 2.07 | 2.41 | 2.42 | 2.37 |
| Magenta | 1.79 | 1.73 | 1.76 | 1.55 | 1.76 | 1.74 | 1.78 |
| Red | 1.69 | 1.70 | 1.70 | 1.54 | 1.72 | 1.70 | 1.67 |
| Yellow | 1.02 | 1.00 | 1.03 | 0.97 | 1.02 | 1.04 | 1.02 |
| Purple | 1.56 | 1.46 | 1.74 | 1.30 | 1.83 | 1.78 | 1.74 |
| Green | 1.53 | 1.44 | 1.72 | 1.36 | 1.69 | 1.73 | 1.61 |
| Cyan | 1.78 | 1.64 | 1.78 | 1.53 | 1.89 | 1.82 | 1.80 |

Summary of Examples 31 to 37

| | Example | | | | | | |
|---|---|---|---|---|---|---|---|
| | 31 | 32 | 33 | 34 | 35 | 36 | 37 |
| Undercoat | U-5 | U-5 | U-5 | U-5 | U-5 | U-5 | U-5 |
| Layer | | | | | | | |
| Overcoat Ink | I | II | III | IV | V | VI | VII |
| Jet Receptive | | | | | | | |
| Layer | | | | | | | |

Image Densities

| | | | | | | | |
|---|---|---|---|---|---|---|---|
| HP-940C | | | | | | | |
| Black | 2.07 | 2.09 | 2.30 | 2.10 | 2.12 | 2.32 | 2.06 |
| Magenta | 1.99 | 2.03 | 2.15 | 1.98 | 2.01 | 2.12 | 2.03 |
| Red | 1.59 | 1.63 | 1.67 | 1.59 | 1.61 | 1.66 | 1.63 |
| Yellow | 1.21 | 1.22 | 1.28 | 1.23 | 1.23 | 1.26 | 1.21 |
| Purple | 2.18 | 2.22 | 2.41 | 2.15 | 2.27 | 2.40 | 2.24 |
| Green | 1.34 | 1.33 | 1.38 | 1.32 | 1.38 | 1.39 | 1.37 |
| Cyan | 1.16 | 1.12 | 1.20 | 1.11 | 1.23 | 1.21 | 1.19 |
| EPSON 888 | | | | | | | |
| Black | 2.40 | 2.31 | 2.50 | 2.16 | 2.46 | 2.47 | 2.48 |
| Magenta | 1.82 | 1.84 | 1.90 | 1.78 | 1.85 | 1.88 | 1.92 |
| Red | 1.83 | 1.85 | 1.89 | 1.81 | 1.83 | 1.83 | 1.92 |
| Yellow | 1.29 | 1.25 | 1.30 | 1.27 | 1.32 | 1.30 | 1.33 |
| Purple | 2.31 | 2.30 | 2.57 | 2.36 | 2.40 | 2.64 | 2.44 |
| Green | 2.05 | 2.01 | 2.29 | 1.99 | 2.15 | 2.27 | 2.15 |
| Cyan | 2.21 | 2.10 | 2.44 | 2.03 | 2.40 | 2.44 | 2.26 |
| EPSON 1270 | | | | | | | |
| Black | 2.29 | 2.24 | 2.50 | 2.12 | 2.40 | 2.48 | 2.28 |
| Magenta | 1.69 | 1.72 | 1.74 | 1.57 | 1.75 | 1.73 | 1.77 |
| Red | 1.68 | 1.70 | 1.74 | 1.58 | 1.73 | 1.71 | 1.74 |
| Yellow | 1.02 | 1.00 | 1.03 | 0.97 | 1.05 | 1.03 | 1.03 |
| Purple | 1.68 | 1.55 | 1.74 | 1.34 | 1.90 | 1.88 | 1.80 |
| Green | 1.55 | 1.47 | 1.72 | 1.36 | 1.75 | 1.77 | 1.66 |
| Cyan | 1.76 | 1.68 | 1.75 | 1.55 | 1.94 | 1.85 | 1.82 |

Summary of Examples 38 to 44

| | Example | | | | | | |
|---|---|---|---|---|---|---|---|
| | 38 | 39 | 40 | 41 | 42 | 15 | 44 |
| Undercoat Ink | U-6 | U-6 | U-6 | U-6 | U-6 | U-6 | U-6 |
| Jet Receptive | | | | | | | |
| Layer | | | | | | | |
| Overcoat Ink | I | II | III | IV | V | VI | VII |
| Jet Receptive | | | | | | | |
| Layer | | | | | | | |

Image Densities

| | | | | | | | |
|---|---|---|---|---|---|---|---|
| HP-940C | | | | | | | |
| Black | 2.06 | 2.19 | 2.34 | 2.08 | 2.05 | 2.31 | 2.07 |
| Magenta | 1.92 | 2.08 | 2.12 | 1.94 | 1.95 | 2.16 | 2.01 |
| Red | 1.59 | 1.67 | 1.72 | 1.59 | 1.59 | 1.71 | 1.64 |
| Yellow | 1.21 | 1.23 | 1.29 | 1.23 | 1.21 | 1.29 | 1.23 |
| Purple | 2.15 | 2.21 | 2.44 | 2.10 | 2.21 | 2.43 | 2.21 |
| Green | 1.31 | 1.33 | 1.38 | 1.29 | 1.39 | 1.39 | 1.38 |
| Cyan | 1.16 | 1.12 | 1.19 | 1.10 | 1.24 | 1.22 | 1.22 |
| EPSON 888 | | | | | | | |
| Black | 2.37 | 2.40 | 2.53 | 2.14 | 2.51 | 2.55 | 2.48 |
| Magenta | 1.85 | 1.88 | 1.85 | 1.65 | 1.92 | 1.86 | 1.89 |
| Red | 1.82 | 1.85 | 1.88 | 1.66 | 1.93 | 1.88 | 1.87 |
| Yellow | 1.33 | 1.34 | 1.32 | 1.26 | 1.34 | 1.32 | 1.35 |
| Purple | 2.31 | 2.34 | 2.59 | 2.02 | 2.46 | 2.59 | 2.44 |
| Green | 2.02 | 1.97 | 2.18 | 1.71 | 2.07 | 2.22 | 2.12 |
| Cyan | 2.21 | 2.10 | 2.47 | 1.91 | 2.17 | 2.47 | 2.33 |
| EPSON 1270 | | | | | | | |
| Black | 2.33 | 2.09 | 2.49 | 2.12 | 2.36 | 2.53 | 2.42 |
| Magenta | 1.72 | 1.73 | 1.74 | 1.55 | 1.71 | 1.75 | 1.77 |
| Red | 1.65 | 1.71 | 1.73 | 1.55 | 1.69 | 1.72 | 1.75 |
| Yellow | 1.01 | 1.00 | 1.04 | 1.01 | 1.06 | 1.04 | 1.04 |
| Purple | 1.60 | 1.47 | 1.74 | 1.38 | 1.88 | 1.80 | 1.79 |
| Green | 1.50 | 1.46 | 1.68 | 1.31 | 1.71 | 1.74 | 1.64 |
| Cyan | 1.76 | 1.69 | 1.83 | 1.59 | 1.96 | 1.84 | 1.85 |

Working Examples 1 to 44 generally demonstrate that images printed on the glossy ink jet recording materials of the present invention by the HP-940C, EPSON 888 and EPSON 1270 printers had acceptable image densities for the colors tested even when the coating formulations for the undercoat and overcoat ink jet receptive layers were varied to the extent noted in Tables A and B, hereinabove. As can be seen when comparing the image densities shown in Table 1 with those shown for competitive medias in Table 9, the black image densities for the images recorded on the recording material of the present invention fall within the ranges for the black image densities for the images recorded on competitive media.

### EXAMPLES 45 to 88

In these examples, the test samples described above were imaged using HP-940c, EPSON 888 and EPSON 1270 narrow format ink jet printers and the image densities of the formed images measured and the sum of the image densities for the colors tested for each sample added together. The test samples were also evaluated for gloss, waterfastness and lightfastness. The results are set forth in Table 2, hereinbelow. In addition, image densities for each color tested for these test samples on each ink jet printer are set forth in Table 2A, hereinbelow.

TABLE 2

| | | | | | Sum of Image | | | % | | % | |
|---|---|---|---|---|---|---|---|---|---|---|---|
| | Under- | Over- | | | Densities | | | Waterfastness | | Lightfastness | |
| | coat | coat | Gloss | | HP | Epson | Epson | HP | Epson | HP | Epson |
| Example | Layer | Layer | 60° | 85° | 940C | 888 | 1270 | 940C | 888 | 940C | 888 |

Summary of Examples 45 to 67

| | | | | | | | | | | | |
|---|---|---|---|---|---|---|---|---|---|---|---|
| 45 | U-1 | I | 46 | 68 | 11.72 | 14.16 | 11.35 | 97 | 103 | 94 | 98 |
| 46 | U-1 | II | 42 | 71 | 11.65 | 13.89 | 11.19 | 105 | 101 | 94 | 95 |
| 47 | U-1 | III | 48 | 76 | 12.40 | 14.48 | 11.76 | 104 | 103 | 90 | 98 |
| 48 | U-1 | IV | 42 | 70 | 11.07 | 12.38 | 10.32 | 104 | 100 | 92 | 95 |
| 49 | U-1 | V | 45 | 74 | 11.80 | 14.43 | 12.10 | 104 | 101 | 91 | 97 |
| 50 | U-1 | VI | 55 | 77 | 12.25 | 14.69 | 11.82 | 106 | 102 | 91 | 96 |
| 51 | U-1 | VII | 45 | 64 | 11.83 | 14.61 | 11.97 | 105 | 102 | 94 | 96 |
| 52 | U-1 | VIII | 38 | 66 | 11.39 | 13.71 | 12.13 | 106 | 100 | 92 | 97 |
| 53 | U-1 | IX | 25 | 68 | 10.58 | 12.09 | 10.54 | 105 | 102 | 94 | 99 |
| 54 | U-2 | I | 43 | 69 | 11.51 | 13.99 | 11.55 | 106 | 102 | 95 | 98 |
| 55 | U-2 | II | 45 | 77 | 11.75 | 13.67 | 11.41 | 105 | 104 | 93 | 98 |
| 56 | U-2 | III | 53 | 77 | 12.30 | 14.78 | 12.37 | 105 | 105 | 92 | 99 |
| 57 | U-2 | IV | 45 | 76 | 11.33 | 12.32 | 10.41 | 104 | 103 | 92 | 98 |
| 58 | U-2 | V | 45 | 74 | 11.62 | 14.48 | 12.36 | 105 | 101 | 95 | 98 |
| 59 | U-2 | VI | 47 | 73 | 12.31 | 14.73 | 13.15 | 103 | 104 | 91 | 99 |
| 60 | U-2 | VII | 44 | 72 | 11.75 | 14.50 | 13.26 | 106 | 102 | 95 | 99 |
| 61 | U-3 | I | 45 | 73 | 11.72 | 13.94 | 11.54 | 105 | 104 | 94 | 98 |
| 62 | U-3 | II | 46 | 76 | 11.67 | 14.03 | 11.52 | 107 | 104 | 95 | 96 |
| 63 | U-3 | III | 52 | 76 | 12.48 | 14.68 | 12.52 | 106 | 104 | 92 | 98 |
| 64 | U-3 | IV | 44 | 76 | 11.34 | 12.65 | 10.54 | 105 | 102 | 92 | 96 |
| 65 | U-3 | V | 41 | 61 | 11.57 | 14.38 | 12.30 | 106 | 102 | 96 | 97 |
| 66 | U-3 | VI | 52 | 76 | 12.46 | 14.71 | 12.51 | 105 | 103 | 92 | 98 |
| 67 | U-3 | VII | 48 | 73 | 11.80 | 14.66 | 12.26 | 107 | 101 | 96 | 98 |

Summary of Examples 68 to 88

| | | | | | | | | | | | |
|---|---|---|---|---|---|---|---|---|---|---|---|
| 68 | U-4 | I | 45 | 77 | 11.42 | 13.90 | 11.68 | 106 | 103 | 94 | 98 |
| 69 | U-4 | II | 42 | 78 | 11.61 | 13.78 | 11.28 | 106 | 104 | 95 | 96 |
| 70 | U-4 | III | 51 | 77 | 12.28 | 14.74 | 12.21 | 105 | 104 | 92 | 98 |
| 71 | U-4 | IV | 43 | 73 | 11.31 | 12.54 | 10.32 | 104 | 102 | 91 | 96 |
| 72 | U-4 | V | 45 | 76 | 11.68 | 14.37 | 12.32 | 104 | 101 | 94 | 97 |
| 73 | U-4 | VI | 51 | 80 | 12.35 | 14.84 | 12.23 | 104 | 103 | 91 | 97 |
| 74 | U-4 | VII | 46 | 77 | 11.77 | 14.65 | 11.99 | 103 | 101 | 93 | 97 |
| 75 | U-5 | I | 45 | 79 | 11.54 | 13.91 | 11.67 | 106 | 103 | 94 | 97 |
| 76 | U-5 | II | 40 | 78 | 11.64 | 13.66 | 11.36 | 105 | 104 | 94 | 97 |
| 77 | U-5 | III | 50 | 79 | 12.39 | 14.89 | 12.22 | 103 | 102 | 93 | 97 |
| 78 | U-5 | IV | 42 | 77 | 11.48 | 13.40 | 10.49 | 101 | 100 | 93 | 92 |
| 79 | U-5 | V | 46 | 79 | 11.85 | 14.41 | 12.52 | 103 | 102 | 96 | 91 |
| 80 | U-5 | VI | 52 | 81 | 12.36 | 14.83 | 12.45 | 104 | 103 | 90 | 97 |
| 81 | U-5 | VII | 46 | 77 | 11.73 | 14.50 | 12.10 | 105 | 103 | 92 | 97 |
| 82 | U-6 | I | 45 | 79 | 11.40 | 13.91 | 11.57 | 106 | 103 | 95 | 98 |
| 83 | U-6 | II | 43 | 77 | 11.83 | 13.88 | 11.15 | 104 | 108 | 93 | 97 |
| 84 | U-6 | III | 49 | 77 | 12.48 | 14.82 | 12.25 | 103 | 103 | 91 | 98 |
| 85 | U-6 | IV | 43 | 77 | 11.33 | 12.35 | 10.51 | 103 | 103 | 91 | 96 |
| 86 | U-6 | V | 44 | 77 | 11.64 | 14.4 | 12.37 | 105 | 100 | 95 | 95 |
| 87 | U-6 | VI | 47 | 77 | 12.51 | 14.89 | 12.42 | 103 | 103 | 91 | 98 |
| 88 | U-6 | VII | 44 | 76 | 11.76 | 14.48 | 12.26 | 106 | 101 | 95 | 97 |

The data shown in Table 2 illustrates the combination of properties demonstrated by the glossy ink jet recording material of the present invention. In addition to demonstrating acceptable image density levels for images printed on both HP and EPSON printer platforms, the inventive recording material demonstrated good gloss and excellent waterfastness and lightfastness. The image density sums shown in Table 2 indicate that the composition of the overcoat ink jet receptive layer did impact upon the measured image densities of the printed images.

TABLE 2A

| | Under- | Over- | | | | | | | | | | | | | | |
|---|---|---|---|---|---|---|---|---|---|---|---|---|---|---|---|---|
| | Coat | Coat | HP 940c Densities | | | | | | | Epson 888 Densities | | | | | | |
| Example | Layer | Layer | Bk | M | R | Y | P | G | C | Bk | M | R | Y | P | G | C |
| 45 | U-1 | I | 2.12 | 2.03 | 1.63 | 1.22 | 2.25 | 1.32 | 1.15 | 2.46 | 1.88 | 1.85 | 1.32 | 2.38 | 2.05 | 2.22 |
| 54 | U-2 | I | 2.09 | 2.01 | 1.60 | 1.22 | 2.17 | 1.30 | 1.12 | 2.44 | 1.89 | 1.84 | 1.35 | 2.33 | 2.04 | 2.10 |
| 61 | U-3 | I | 2.15 | 2.03 | 1.64 | 1.22 | 2.23 | 1.31 | 1.14 | 2.39 | 1.84 | 1.82 | 1.31 | 2.33 | 2.08 | 2.17 |
| 68 | U-4 | I | 2.03 | 1.97 | 1.60 | 1.21 | 2.17 | 1.31 | 1.13 | 2.41 | 1.84 | 1.81 | 1.31 | 2.29 | 2.06 | 2.18 |
| 75 | U-5 | I | 2.07 | 1.99 | 1.59 | 1.21 | 2.18 | 1.34 | 1.16 | 2.40 | 1.82 | 1.83 | 1.29 | 2.31 | 2.05 | 2.21 |
| 82 | U-6 | I | 2.06 | 1.92 | 1.59 | 1.21 | 2.15 | 1.31 | 1.16 | 2.37 | 1.85 | 1.82 | 1.33 | 2.31 | 2.02 | 2.21 |
| Average | | | 2.09 | 1.99 | 1.61 | 1.22 | 2.19 | 1.32 | 1.14 | 2.41 | 1.85 | 1.83 | 1.32 | 2.33 | 2.05 | 2.18 |
| 46 | U-1 | II | 2.10 | 2.04 | 1.62 | 1.23 | 2.22 | 1.33 | 1.11 | 2.42 | 1.91 | 1.91 | 1.33 | 2.28 | 1.98 | 2.06 |
| 55 | U-2 | II | 2.17 | 2.06 | 1.64 | 1.24 | 2.23 | 1.31 | 1.10 | 2.22 | 1.88 | 1.83 | 1.34 | 2.31 | 2.01 | 2.08 |
| 62 | U-3 | II | 2.14 | 2.02 | 1.65 | 1.23 | 2.24 | 1.30 | 1.09 | 2.43 | 1.87 | 1.85 | 1.32 | 2.34 | 2.07 | 2.15 |
| 69 | U-4 | II | 2.14 | 2.03 | 1.63 | 1.22 | 2.20 | 1.29 | 1.10 | 2.35 | 1.85 | 1.85 | 1.31 | 2.31 | 2.01 | 2.10 |
| 76 | U-5 | II | 2.09 | 2.03 | 1.63 | 1.22 | 2.22 | 1.33 | 1.12 | 2.31 | 1.84 | 1.85 | 1.25 | 2.30 | 2.01 | 2.10 |
| 83 | U-6 | II | 2.19 | 2.08 | 1.67 | 1.23 | 2.21 | 1.33 | 1.12 | 2.40 | 1.88 | 1.85 | 1.34 | 2.34 | 1.97 | 2.10 |
| Average | | | 2.14 | 2.04 | 1.64 | 1.23 | 2.22 | 1.32 | 1.11 | 2.36 | 1.87 | 1.86 | 1.32 | 2.31 | 2.01 | 2.10 |
| 47 | U-1 | III | 2.27 | 2.15 | 1.68 | 1.28 | 2.43 | 1.38 | 1.21 | 2.49 | 1.84 | 1.77 | 1.30 | 2.49 | 2.17 | 2.42 |
| 56 | U-2 | III | 2.33 | 2.11 | 1.66 | 1.27 | 2.38 | 1.36 | 1.16 | 2.56 | 1.86 | 1.78 | 1.34 | 2.51 | 2.22 | 2.51 |
| 63 | U-3 | III | 2.36 | 2.15 | 1.71 | 1.28 | 2.43 | 1.37 | 1.18 | 2.49 | 1.84 | 1.85 | 1.30 | 2.51 | 2.22 | 2.47 |
| 70 | U-4 | III | 2.34 | 2.14 | 1.67 | 1.26 | 2.37 | 1.34 | 1.16 | 2.57 | 1.82 | 1.83 | 1.30 | 2.54 | 2.23 | 2.45 |
| 77 | U-5 | III | 2.30 | 2.15 | 1.67 | 1.28 | 2.41 | 1.38 | 1.20 | 2.50 | 1.90 | 1.89 | 1.30 | 2.57 | 2.29 | 2.44 |
| 84 | U-6 | III | 2.34 | 2.12 | 1.72 | 1.29 | 2.44 | 1.38 | 1.19 | 2.53 | 1.85 | 1.88 | 1.32 | 2.59 | 2.18 | 2.47 |
| Average | | | 2.32 | 2.14 | 1.69 | 1.28 | 2.41 | 1.37 | 1.18 | 2.52 | 1.85 | 1.83 | 1.31 | 2.54 | 2.22 | 2.46 |
| 48 | U-1 | IV | 2.06 | 1.92 | 1.56 | 1.21 | 1.99 | 1.25 | 1.08 | 2.14 | 1.71 | 1.74 | 1.25 | 1.97 | 1.72 | 1.85 |
| 57 | U-2 | IV | 2.14 | 1.96 | 1.58 | 1.22 | 2.09 | 1.27 | 1.07 | 2.13 | 1.65 | 1.63 | 1.27 | 2.02 | 1.74 | 1.88 |
| 64 | U-3 | IV | 2.13 | 1.95 | 1.59 | 1.21 | 2.11 | 1.27 | 1.08 | 2.15 | 1.67 | 1.68 | 1.25 | 2.11 | 1.84 | 1.95 |
| 71 | U-4 | IV | 2.11 | 1.97 | 1.59 | 1.21 | 2.10 | 1.26 | 1.07 | 2.13 | 1.67 | 1.69 | 1.24 | 2.08 | 1.82 | 1.91 |
| 78 | U-5 | IV | 2.10 | 1.98 | 1.59 | 1.23 | 2.15 | 1.32 | 1.11 | 2.16 | 1.78 | 1.81 | 1.27 | 2.36 | 1.99 | 2.03 |
| 85 | U-6 | IV | 2.08 | 1.94 | 1.59 | 1.23 | 2.10 | 1.29 | 1.10 | 2.14 | 1.65 | 1.66 | 1.26 | 2.02 | 1.71 | 1.91 |
| Average | | | 2.10 | 1.95 | 1.58 | 1.22 | 2.09 | 1.28 | 1.09 | 2.14 | 1.69 | 1.70 | 1.26 | 2.09 | 1.80 | 1.92 |
| 49 | U-1 | V | 2.13 | 2.01 | 1.62 | 1.22 | 2.28 | 1.34 | 1.20 | 2.47 | 1.88 | 1.85 | 1.42 | 2.31 | 2.16 | 2.34 |
| 58 | U-2 | V | 2.06 | 1.96 | 1.59 | 1.21 | 2.27 | 1.34 | 1.19 | 2.48 | 1.89 | 1.83 | 1.35 | 2.41 | 2.16 | 2.36 |
| 65 | U-3 | V | 2.06 | 1.95 | 1.59 | 1.20 | 2.25 | 1.34 | 1.18 | 2.48 | 1.87 | 1.82 | 1.32 | 2.40 | 2.13 | 2.36 |
| 72 | U-4 | V | 2.07 | 1.99 | 1.61 | 1.21 | 2.26 | 1.35 | 1.19 | 2.47 | 1.85 | 1.82 | 1.31 | 2.40 | 2.14 | 2.38 |
| 79 | U-5 | V | 2.12 | 2.01 | 1.61 | 1.23 | 2.27 | 1.38 | 1.23 | 2.46 | 1.85 | 1.83 | 1.32 | 2.40 | 2.15 | 2.40 |
| 86 | U-6 | V | 2.05 | 1.95 | 1.59 | 1.21 | 2.21 | 1.39 | 1.24 | 2.51 | 1.92 | 1.93 | 1.34 | 2.46 | 2.07 | 2.17 |
| Average | | | 2.08 | 1.98 | 1.60 | 1.21 | 2.26 | 1.36 | 1.21 | 2.48 | 1.88 | 1.85 | 1.34 | 2.40 | 2.14 | 2.34 |
| 50 | U-1 | VI | 2.33 | 2.12 | 1.65 | 1.26 | 2.34 | 1.36 | 1.19 | 2.53 | 1.89 | 1.92 | 1.30 | 2.54 | 2.17 | 2.34 |
| 59 | U-2 | VI | 2.32 | 2.12 | 1.66 | 1.27 | 2.39 | 1.37 | 1.18 | 2.54 | 1.83 | 1.77 | 1.33 | 2.51 | 2.23 | 2.52 |
| 66 | U-3 | VI | 2.37 | 2.14 | 1.71 | 1.28 | 2.42 | 1.36 | 1.18 | 2.57 | 1.83 | 1.84 | 1.30 | 2.53 | 2.20 | 2.44 |
| 73 | U-4 | VI | 2.35 | 2.13 | 1.67 | 1.26 | 2.40 | 1.36 | 1.18 | 2.56 | 1.83 | 1.85 | 1.30 | 2.59 | 2.24 | 2.47 |
| 80 | U-5 | VI | 2.32 | 2.12 | 1.66 | 1.26 | 2.40 | 1.39 | 1.21 | 2.47 | 1.88 | 1.83 | 1.30 | 2.64 | 2.27 | 2.44 |
| 87 | U-6 | VI | 2.31 | 2.16 | 1.71 | 1.29 | 2.43 | 1.39 | 1.22 | 2.55 | 1.86 | 1.88 | 1.32 | 2.59 | 2.22 | 2.47 |
| Average | | | 2.33 | 2.13 | 1.68 | 1.27 | 2.40 | 1.37 | 1.19 | 2.54 | 1.85 | 1.85 | 1.31 | 2.57 | 2.22 | 2.45 |
| 51 | U-1 | VII | 2.13 | 2.03 | 1.64 | 1.23 | 2.27 | 1.35 | 1.18 | 2.54 | 1.93 | 1.91 | 1.32 | 2.47 | 2.17 | 2.27 |
| 60 | U-2 | VII | 2.11 | 2.01 | 1.64 | 1.22 | 2.24 | 1.35 | 1.18 | 2.53 | 1.91 | 1.86 | 1.36 | 2.35 | 2.17 | 2.32 |
| 67 | U-3 | VII | 2.14 | 2.05 | 1.65 | 1.22 | 2.25 | 1.32 | 1.17 | 2.58 | 1.90 | 1.88 | 1.33 | 2.48 | 2.15 | 2.34 |
| 74 | U-4 | VII | 2.11 | 2.05 | 1.63 | 1.21 | 2.26 | 1.33 | 1.18 | 2.55 | 1.90 | 1.84 | 1.33 | 2.50 | 2.17 | 2.36 |
| 81 | U-5 | VII | 2.06 | 2.03 | 1.63 | 1.21 | 2.24 | 1.37 | 1.19 | 2.48 | 1.92 | 1.92 | 1.33 | 2.44 | 2.15 | 2.26 |
| 88 | U-6 | VII | 2.07 | 2.01 | 1.64 | 1.23 | 2.21 | 1.38 | 1.22 | 2.48 | 1.89 | 1.87 | 1.35 | 2.44 | 2.12 | 2.33 |
| Average | | | 2.10 | 2.03 | 1.64 | 1.22 | 2.25 | 1.35 | 1.19 | 2.53 | 1.91 | 1.88 | 1.34 | 2.45 | 2.16 | 2.31 |

| Epson 1270 Densities | | | | | | | |
|---|---|---|---|---|---|---|---|
| Example | Bk | M | R | Y | P | G | C |
| 45 | 2.24 | 1.74 | 1.72 | 1.01 | 1.50 | 1.44 | 1.70 |
| 54 | 2.36 | 1.77 | 1.75 | 0.99 | 1.50 | 1.48 | 1.70 |
| 61 | 2.27 | 1.74 | 1.70 | 1.00 | 1.57 | 1.52 | 1.74 |
| 68 | 2.31 | 1.79 | 1.69 | 1.02 | 1.56 | 1.53 | 1.78 |
| 75 | 2.29 | 1.69 | 1.68 | 1.02 | 1.68 | 1.55 | 1.76 |
| 82 | 2.33 | 1.72 | 1.65 | 1.01 | 1.60 | 1.50 | 1.76 |
| Average | 2.30 | 1.74 | 1.70 | 1.01 | 1.57 | 1.50 | 1.74 |
| 46 | 2.36 | 1.74 | 1.71 | 1.00 | 1.37 | 1.39 | 1.62 |
| 55 | 2.38 | 1.77 | 1.74 | 1.00 | 1.43 | 1.42 | 1.67 |
| 62 | 2.37 | 1.74 | 1.74 | 1.00 | 1.51 | 1.48 | 1.68 |
| 69 | 2.31 | 1.73 | 1.70 | 1.00 | 1.46 | 1.44 | 1.64 |
| 76 | 2.24 | 1.72 | 1.70 | 1.00 | 1.55 | 1.47 | 1.68 |
| 83 | 2.09 | 1.73 | 1.71 | 1.00 | 1.47 | 1.46 | 1.69 |
| Average | 2.29 | 1.74 | 1.72 | 1.00 | 1.47 | 1.44 | 1.66 |
| 47 | 2.48 | 1.75 | 1.70 | 1.03 | 1.51 | 1.52 | 1.77 |
| 56 | 2.56 | 1.78 | 1.74 | 1.03 | 1.70 | 1.71 | 1.85 |
| 63 | 2.56 | 1.76 | 1.73 | 1.04 | 1.80 | 1.75 | 1.88 |
| 70 | 2.48 | 1.76 | 1.70 | 1.03 | 1.74 | 1.72 | 1.78 |
| 77 | 2.50 | 1.74 | 1.74 | 1.03 | 1.74 | 1.72 | 1.75 |
| 84 | 2.49 | 1.74 | 1.73 | 1.04 | 1.74 | 1.68 | 1.83 |
| Average | 2.51 | 1.76 | 1.72 | 1.03 | 1.71 | 1.68 | 1.81 |
| 48 | 2.09 | 1.57 | 1.56 | 0.97 | 1.28 | 1.33 | 1.52 |
| 57 | 2.08 | 1.56 | 1.54 | 0.97 | 1.34 | 1.36 | 1.56 |
| 64 | 2.09 | 1.58 | 1.56 | 0.97 | 1.39 | 1.38 | 1.57 |
| 71 | 2.07 | 1.55 | 1.54 | 0.97 | 1.30 | 1.36 | 1.53 |
| 78 | 2.12 | 1.57 | 1.58 | 0.97 | 1.34 | 1.36 | 1.55 |
| 85 | 2.12 | 1.55 | 1.55 | 1.01 | 1.38 | 1.31 | 1.59 |
| Average | 2.10 | 1.56 | 1.56 | 0.98 | 1.34 | 1.35 | 1.55 |
| 49 | 2.40 | 1.76 | 1.73 | 1.02 | 1.75 | 1.60 | 1.84 |
| 58 | 2.43 | 1.78 | 1.74 | 1.02 | 1.82 | 1.66 | 1.91 |
| 65 | 2.28 | 1.76 | 1.73 | 1.04 | 1.86 | 1.71 | 1.92 |
| 72 | 2.41 | 1.76 | 1.72 | 1.02 | 1.83 | 1.69 | 1.89 |
| 79 | 2.40 | 1.75 | 1.73 | 1.05 | 1.90 | 1.75 | 1.94 |
| 86 | 2.36 | 1.71 | 1.69 | 1.06 | 1.88 | 1.71 | 1.96 |
| Average | 2.38 | 1.75 | 1.72 | 1.04 | 1.84 | 1.69 | 1.91 |
| 50 | 2.50 | 1.76 | 1.73 | 1.04 | 1.53 | 1.51 | 1.75 |
| 59 | 2.56 | 1.84 | 1.75 | 1.24 | 1.97 | 1.79 | 2.00 |
| 66 | 2.49 | 1.76 | 1.73 | 1.04 | 1.85 | 1.76 | 1.88 |
| 73 | 2.42 | 1.74 | 1.70 | 1.04 | 1.78 | 1.73 | 1.82 |
| 80 | 2.48 | 1.73 | 1.71 | 1.03 | 1.88 | 1.77 | 1.85 |
| 87 | 2.53 | 1.75 | 1.72 | 1.04 | 1.80 | 1.74 | 1.84 |
| Average | 2.50 | 1.76 | 1.72 | 1.07 | 1.80 | 1.72 | 1.86 |
| 51 | 2.46 | 1.79 | 1.77 | 1.03 | 1.62 | 1.56 | 1.74 |
| 60 | 2.53 | 1.88 | 1.84 | 1.25 | 1.98 | 1.74 | 2.04 |
| 67 | 2.45 | 1.79 | 1.78 | 1.03 | 1.74 | 1.64 | 1.83 |
| 74 | 2.37 | 1.78 | 1.67 | 1.02 | 1.74 | 1.61 | 1.80 |
| 81 | 2.28 | 1.77 | 1.74 | 1.03 | 1.80 | 1.66 | 1.82 |
| 88 | 2.42 | 1.77 | 1.75 | 1.04 | 1.79 | 1.64 | 1.85 |
| Average | 2.42 | 1.80 | 1.76 | 1.07 | 1.78 | 1.64 | 1.85 |

The data shown in Table 2A more clearly demonstrate the impact of the overcoat layer composition on the measured image densities of the printed images. While fairly high optical densities were achieved by a majority of the samples tested, Examples 47, 56, 63, 70, 77, 84 and 50, 59, 66, 73, 80, 87 indicate that the use of overcoat layers III and VI results in higher black and purple image densities using the HP 940c printer. Examples 50, 59, 66, 73, 80, 87 and 51, 60, 67, 74, 81, 88 show that the use of overcoat layers VI and VII results in higher black and purple image densities using the EPSON 888 printer, while the use of overcoat layer VI is preferred when using the EPSON 1270 printer, as shown by Examples 50, 59, 66, 73, 80, 87.

### EXAMPLES 89 to 130

In these examples, the test samples described above were imaged using HP-940c, EPSON 888 and EPSON 1270 narrow format ink jet printers, the image densities of the formed images measured and recorded, and the test samples evaluated for gloss, waterfastness and lightfastness. The results are set forth in Table 3, hereinbelow.

TABLE 3

| | | | | | Sum of Image | | | % | | % | |
|---|---|---|---|---|---|---|---|---|---|---|---|
| | Under- | Over- | | | Densities | | | Waterfastness | | Lightfastness | |
| | coat | coat | Gloss | | HP | Epson | Epson | HP | Epson | HP | Epson |
| Example | Layer | Layer | 60° | 85° | 940C | 888 | 1270 | 940C | 888 | 940C | 888 |

Summary of Examples 89 to 106

| | | | | | | | | | | | |
|---|---|---|---|---|---|---|---|---|---|---|---|
| 89 | U-1 | I | 46 | 68 | 11.72 | 14.16 | 11.35 | 97 | 103 | 94 | 98 |
| 90 | U-2 | I | 43 | 69 | 11.51 | 13.99 | 11.55 | 106 | 102 | 95 | 98 |
| 91 | U-3 | I | 45 | 73 | 11.72 | 13.94 | 11.54 | 105 | 104 | 94 | 98 |
| 92 | U-4 | I | 45 | 77 | 11.42 | 13.90 | 11.68 | 106 | 103 | 94 | 98 |
| 93 | U-5 | I | 45 | 79 | 11.54 | 13.91 | 11.67 | 106 | 103 | 94 | 97 |
| 94 | U-6 | I | 45 | 79 | 11.40 | 13.91 | 11.57 | 106 | 103 | 95 | 98 |
| 95 | U-1 | II | 42 | 71 | 11.65 | 13.89 | 11.19 | 105 | 101 | 94 | 95 |
| 96 | U-2 | II | 45 | 77 | 11.75 | 13.67 | 11.41 | 105 | 104 | 93 | 98 |
| 97 | U-3 | II | 46 | 76 | 11.67 | 14.03 | 11.52 | 107 | 104 | 95 | 96 |
| 98 | U-4 | II | 42 | 78 | 11.61 | 13.78 | 11.28 | 106 | 104 | 95 | 96 |
| 99 | U-5 | II | 40 | 78 | 11.64 | 13.66 | 11.36 | 105 | 104 | 94 | 97 |
| 100 | U-6 | II | 43 | 77 | 11.83 | 13.88 | 11.15 | 104 | 108 | 93 | 97 |
| 101 | U-1 | III | 48 | 76 | 12.40 | 14.48 | 11.76 | 104 | 103 | 90 | 98 |
| 102 | U-2 | III | 53 | 77 | 12.30 | 14.78 | 12.37 | 105 | 105 | 92 | 99 |
| 103 | U-3 | III | 52 | 76 | 12.48 | 14.68 | 12.52 | 106 | 104 | 92 | 98 |
| 104 | U-4 | III | 51 | 77 | 12.28 | 14.74 | 12.21 | 105 | 104 | 92 | 98 |
| 105 | U-5 | III | 50 | 79 | 12.39 | 14.89 | 12.22 | 103 | 102 | 93 | 97 |
| 106 | U-6 | III | 49 | 77 | 12.48 | 14.82 | 12.25 | 103 | 103 | 91 | 98 |

Summary of Examples 107 to 130

| | | | | | | | | | | | |
|---|---|---|---|---|---|---|---|---|---|---|---|
| 107 | U-1 | IV | 42 | 70 | 11.07 | 12.38 | 10.32 | 104 | 100 | 92 | 95 |
| 108 | U-2 | IV | 45 | 76 | 11.33 | 12.32 | 10.41 | 104 | 103 | 92 | 98 |
| 109 | U-3 | IV | 44 | 76 | 11.34 | 12.65 | 10.54 | 105 | 102 | 92 | 96 |
| 110 | U-4 | IV | 43 | 73 | 11.31 | 12.54 | 10.32 | 104 | 102 | 91 | 96 |
| 111 | U-5 | IV | 42 | 77 | 11.48 | 13.40 | 10.49 | 101 | 100 | 93 | 92 |
| 112 | U-6 | IV | 43 | 77 | 11.33 | 12.35 | 10.51 | 103 | 103 | 91 | 96 |
| 113 | U-1 | V | 45 | 74 | 11.80 | 14.43 | 12.10 | 104 | 101 | 91 | 97 |
| 114 | U-2 | V | 45 | 74 | 11.62 | 14.48 | 12.36 | 105 | 101 | 95 | 98 |
| 115 | U-3 | V | 41 | 61 | 11.57 | 14.38 | 12.30 | 106 | 102 | 96 | 97 |
| 116 | U-4 | V | 45 | 76 | 11.68 | 14.37 | 12.32 | 104 | 101 | 94 | 97 |
| 117 | U-5 | V | 46 | 79 | 11.85 | 14.41 | 12.52 | 103 | 102 | 96 | 91 |
| 118 | U-6 | V | 44 | 77 | 11.64 | 14.4 | 12.37 | 105 | 100 | 95 | 95 |
| 119 | U-1 | VI | 55 | 77 | 12.25 | 14.69 | 11.82 | 106 | 102 | 91 | 96 |
| 120 | U-2 | VI | 47 | 73 | 12.31 | 14.73 | 13.15 | 103 | 104 | 91 | 99 |
| 121 | U-3 | VI | 52 | 76 | 12.46 | 14.71 | 12.51 | 105 | 103 | 92 | 98 |
| 122 | U-4 | VI | 51 | 80 | 12.35 | 14.84 | 12.23 | 104 | 103 | 91 | 97 |
| 123 | U-5 | VI | 52 | 81 | 12.36 | 14.83 | 12.45 | 104 | 103 | 90 | 97 |
| 124 | U-6 | VI | 47 | 77 | 12.51 | 14.89 | 12.42 | 103 | 103 | 91 | 98 |
| 125 | U-1 | VII | 45 | 64 | 11.83 | 14.61 | 11.97 | 105 | 102 | 94 | 96 |
| 126 | U-2 | VII | 44 | 72 | 11.75 | 14.50 | 13.26 | 106 | 102 | 95 | 99 |
| 127 | U-3 | VII | 48 | 73 | 11.80 | 14.66 | 12.26 | 107 | 101 | 96 | 98 |
| 128 | U-4 | VII | 46 | 77 | 11.77 | 14.65 | 11.99 | 103 | 101 | 93 | 97 |
| 129 | U-5 | VII | 46 | 77 | 11.70 | 14.50 | 12.10 | 105 | 103 | 92 | 97 |
| 130 | U-6 | VII | 44 | 76 | 11.76 | 14.48 | 12.26 | 106 | 101 | 95 | 97 |

The data shown in Table 3 demonstrates that while changes in the coating formulations used for the undercoat and overcoat layers of the inventive recording material did not impact significantly upon waterfastness and lightfastness, such changes did impact upon imaging performance and gloss. See e.g., Examples 107 to 112 and Examples 119 to 124.

### Part B

### Sample Preparation

For this set of Working Examples, three test samples were prepared and tested. The samples were prepared by (1) applying either a U-1 undercoat layer or a I overcoat layer to a BP-1 base paper to form a first layer having a coating weight of about 11 g/m²; (2) drying the first layer; (3) applying either a U-1 undercoat layer or a I overcoat layer to the first layer to form a second layer having a coating weight of about 14 g/m²; (4) drying the second layer; (5) applying either a U-1 undercoat layer or a I overcoat layer to the second layer to form a third layer having a coating weight of about 14 g/m²; (6) drying the third layer; and (7) calendering the test sample under the conditions described in paragraph number [0107].

### EXAMPLES 131 to 133

In these examples, the test samples described above were imaged using HP-940c, EPSON 888, EPSON 1270 and HP 2500CP ink jet printers and the image densities of the formed images measured and recorded. The results are set forth in Table 4, hereinbelow.

TABLE 4
Summary of Examples 131 to 133

| | Example | | |
|---|---|---|---|
| | 131 | 132 | 133 |
| First Layer | U-1 | U-1 | I |
| Second Layer | U-1 | U-1 | I |
| Third Layer | I | U-1 | I |

Image Densities

| | | | |
|---|---|---|---|
| HP-940C | | | |
| Black | 2.12 | 1.68 | 1.79 |
| Magenta | 2.03 | 1.67 | 1.82 |
| Red | 1.63 | 1.31 | 1.47 |
| Yellow | 1.22 | 1.10 | 1.18 |
| Purple | 2.25 | 1.99 | 2.04 |
| Green | 1.32 | 1.26 | 1.33 |
| Cyan | 1.15 | 1.15 | 1.14 |
| Epson 888 | | | |
| Black | 2.46 | 2.02 | 2.10 |
| Magenta | 1.88 | 1.49 | 1.65 |
| Red | 1.85 | 1.46 | 1.64 |
| Yellow | 1.32 | 1.08 | 1.23 |
| Purple | 2.38 | 2.05 | 2.11 |
| Green | 2.05 | 1.90 | 1.95 |
| Cyan | 2.22 | 2.15 | 2.14 |
| Epson 1270 | | | |
| Black | 2.24 | 1.99 | 2.07 |
| Magenta | 1.74 | 1.44 | 1.64 |
| Red | 1.72 | 1.41 | 1.61 |
| Yellow | 1.01 | 0.99 | 1.07 |
| Purple | 1.50 | 2.00 | 1.77 |
| Green | 1.44 | 1.80 | 1.76 |
| Cyan | 1.70 | 2.10 | 1.92 |
| HP 2500 cp | | | |
| Black | 1.25 | 1.46 | 1.39 |
| Magenta | 1.35 | 1.46 | 1.50 |
| Red | 1.44 | 1.47 | 1.62 |
| Yellow | 0.75 | 0.78 | 0.78 |
| Purple | 1.44 | 1.67 | 1.68 |
| Green | 1.21 | 1.63 | 1.65 |
| Cyan | 1.20 | 1.56 | 1.46 |

The data shown in Table 4 evidences a form of synergism when an undercoat layer is used in conjunction with an outercoat layer in the glossy ink jet recording material of the present invention. More specifically, the image density measurements for one or more tested colors (e.g., HP-940C/Black, Magenta, Red, Yellow, Purple and Green and EPSON 888/all tested colors) for Example 131 were higher than would be expected from the weighted averages for Examples 132 and 133. In addition, Example 132, which represents one embodiment of the present invention, demonstrated acceptable image density levels when imaged using EPSON printers.

### EXAMPLES 134 to 136

In these examples, the test samples described above were imaged using HP-940c, EPSON 888 and EPSON 1270 ink jet printers and the image densities of the formed images measured and the sum of the image densities for the colors tested for each sample were added together. The test samples were also evaluated for gloss, waterfastness and lightfastness. The results are set forth in Table 5, hereinbelow.

TABLE 5
Summary of Examples 134 to 136

| | | | | Sum of Image | | | | % | | % | |
|---|---|---|---|---|---|---|---|---|---|---|---|
| | | | | Densities | | | | Waterfastness | | Lightfastness | |
| | Layer | Gloss | | HP | Epson | Epson | HP | HP | Epson | HP | Epson |
| Example | Structure | 60° | 85° | 940c | 888 | 1270 | 2500 cp | 940C | 888 | 940C | 888 |
| 134 | U-1/U-1/I | 46 | 68 | 11.72 | 14.16 | 11.35 | 8.64 | 97 | 103 | 94 | 98 |
| 135 | U-1/U-1/ | 48 | 79 | 10.16 | 12.15 | 11.77 | 10.03 | 102 | 101 | 97 | 99 |
| | U-1 | | | | | | | | | | |
| 136 | I/I/I | 24 | 59 | 10.77 | 12.82 | 11.84 | 10.08 | 106 | 103 | 99 | 99 |

Working Examples 134 and 135 clearly evidence the fact that the undercoat layer U-1 has a significant impact upon the gloss levels demonstrated by the ink jet recording materials of the present invention. In addition, the gloss levels achieved by the recording materials of the present invention are significantly higher than the gloss levels achieved by Example 136, which employed only overcoat layer I.

### Part C

### Sample Preparation

For this set of Working Examples, the aqueous coating formulations described below in Table C were used to form undercoat layers on BP-2 and BP-3 base papers by (1) applying the coating formulation to the base paper to form a first undercoat layer having a basis weight of 11 g/m², (2) drying the first undercoat layer, (3) applying the same coating formulation to the first undercoat layer to form a second undercoat layer having a basis weight of 14 g/m2, and (4) drying the second undercoat layer.

TABLE C
Coating Formulations For Undercoat Ink Jet Receptive Layer

| | |
|---|---|
| | Undercoat Ink |
| | Jet Receptive |
| Components¹ (parts | Layer |

| per weight) | U-7 | U-8 |
|---|---|---|
| FUMED ALUMINA | 225 | 225 |
| SILICA I | 3.33 | 3.33 |
| CATIONIC LATEX I | 1.78 | 1.78 |
| CATIONIC LATEX II | 1.67 | 3.72 |
| CATIONIC LATEX III | 11.33 | 11.33 |
| POLYURETHANE | 22.22 | 22.22 |
| RESIN II | | |
| BLUEING DYE I² | 0.23 | 0.23 |
| BLUEING DYE II³ | 0.67 | 0.67 |
| WETTING AGENT4 | 0.60 | 0.60 |
| WATER | 13.00 | 13.00 |
| % SOLIDS | 36 | 36 |
| BINDER-TO- | 1:19 | 1:17 |
| PIGMENT RATIO⁵ | | |

¹Parts added, as supplied, unless otherwise specified.
²Supplied at a 24.9% solids, diluted 1:100 with water prior to using.
³Supplied at a 20.5% solids, diluted 1:100 with water prior to using.
⁴Diluted 1:10 with water prior to using.
⁵Dry Basis

The aqueous coating formulations described below in Table D were then applied to each coated base paper to form an overcoat ink jet receptive layer having a basis weight of 14 g/m².

TABLE D
Coating Formulations For Overcoat Ink Jet Receptive Layer

| | Overcoat Ink Jet | | | |
|---|---|---|---|---|
| Components¹ (parts | Receptive Layer | | | |
| per weight) | X | XI | XII | XIII |
| SILICA I | 103.75 | 103.75 | 103.75 | 103.75 |
| SILICA II | 0.83 | 0.83 | 0.83 | 0.83 |
| FUMED ALUMINA | 18.13 | 18.13 | 18.13 | 18.13 |
| CATIONIC LATEX II | 2.50 | 2.50 | 2.50 | 2.50 |
| WETTING AGENT² | 0.30 | 0.30 | 0.30 | 0.30 |
| FWA I/CATIONIC | — | — | 5.50 | 8.80 |
| RESIN (I)³ | | | | |
| FWA I/CATIONIC | — | 2.13 | — | — |
| RESIN (II)⁴ | | | | |
| WATER | 13.5 | 12.2 | 11.8 | 10.8 |
| % SOLIDS | 36 | 36 | 36 | 36 |
| ALUMINA-TO | 1:6 | 1:6 | 1:6 | 1:6 |
| SILICA RATIO⁵ | | | | |
| BINDER-TO- | 1:49 | 1:49 | 1:49 | 1:49 |
| PIGMENT RATIO⁵ | | | | |

¹Parts added, as supplied, unless otherwise specified.
²Diluted 1:10 with water prior to using.
³FWA I/CATIONIC RESIN (I): a blend of 3.45 parts of water, 3.45 of FWA I (TINOPAL ABP-A) and 15 parts of CATIONIC RESIN (ALCOSTAT 167)
⁴FWA I/CATIONIC RESIN (II): a blend of 25.5 parts of water, 7.83 of FWA I (TINOPAL ABP-A) and 15 parts of cationic resin (ALCOSTAT 167)
⁵Dry Basis

### EXAMPLES 137 to 146

In these examples, the test samples described above were imaged using HP-940c, EPSON 888 and EPSON 1270 narrow format ink jet printers and the image densities of the formed images measured and recorded. The results are set forth in Table 6, hereinbelow.

TABLE 6
Summary of Examples 137 to 146

| | Sample | | | | | | | | | |
|---|---|---|---|---|---|---|---|---|---|---|
| | 137 | 138 | 139 | 140 | 141 | 142 | 143 | 144 | 145 | 146 |
| Base Paper | BP-2 | BP-2 | BP-2 | BP-3 | BP-3 | BP-3 | BP-3 | BP-3 | BP-3 | BP-3 |
| Undercoat Layer | U-7 | U-7 | U-7 | U-7 | U-7 | U-7 | U-8 | U-8 | U-8 | U-8 |
| Overcoat Layer | X | XII | XIII | X | XII | XIII | X | XI | XII | XIII |

Image Densities

| | | | | | | | | | | |
|---|---|---|---|---|---|---|---|---|---|---|
| HP-940C | | | | | | | | | | |
| Black | 2.29 | 2.14 | 2.13 | 2.21 | 2.19 | 2.10 | 2.26 | 2.27 | 2.19 | 2.16 |
| Magenta | 2.03 | 2.03 | 2.02 | 2.04 | 2.01 | 1.99 | 2.14 | 2.18 | 2.05 | 2.00 |
| Red | 1.63 | 1.64 | 1.62 | 1.64 | 1.63 | 1.62 | 1.61 | 1.65 | 1.64 | 1.62 |
| Yellow | 1.23 | 1.21 | 1.24 | 1.23 | 1.22 | 1.23 | 1.23 | 1.22 | 1.23 | 1.23 |
| Purple | 2.39 | 2.30 | 2.25 | 2.35 | 2.27 | 2.25 | 2.40 | 2.43 | 2.31 | 2.24 |
| Green | 1.31 | 1.30 | 1.27 | 1.33 | 1.30 | 1.28 | 1.32 | 1.24 | 1.30 | 1.28 |
| Cyan | 1.18 | 1.17 | 1.17 | 1.19 | 1.19 | 1.18 | 1.20 | 1.04 | 1.21 | 1.17 |
| Epson 888 | | | | | | | | | | |
| Black | 2.50 | 2.43 | 2.36 | 2.51 | 2.43 | 2.37 | 2.56 | 2.52 | 2.44 | 2.43 |
| Magenta | 1.88 | 1.87 | 1.84 | 1.86 | 1.89 | 1.84 | 1.89 | 1.88 | 1.89 | 1.93 |
| Red | 1.83 | 1.83 | 1.81 | 1.78 | 1.83 | 1.81 | 1.84 | 1.91 | 1.84 | 1.91 |
| Yellow | 1.34 | 1.40 | 1.42 | 1.34 | 1.40 | 1.40 | 1.37 | 1.35 | 1.42 | 1.44 |
| Purple | 2.41 | 2.07 | 1.82 | 2.45 | 2.06 | 1.78 | 2.49 | 2.54 | 2.07 | 1.99 |
| Green | 2.20 | 1.83 | 1.58 | 2.14 | 1.83 | 1.57 | 2.24 | 2.24 | 1.84 | 1.84 |
| Cyan | 2.48 | 1.92 | 1.75 | 2.49 | 1.89 | 1.78 | 2.50 | 2.45 | 1.86 | 1.91 |
| Epson 1270 | | | | | | | | | | |
| Black | 2.51 | 2.38 | 2.33 | 2.51 | 2.40 | 2.31 | 2.54 | 2.49 | 2.43 | 2.34 |
| Magenta | 1.81 | 1.81 | 1.79 | 1.82 | 1.82 | 1.76 | 1.83 | 1.78 | 1.85 | 1.80 |
| Red | 1.76 | 1.77 | 1.76 | 1.74 | 1.78 | 1.72 | 1.75 | 1.78 | 1.80 | 1.75 |
| Yellow | 1.09 | 1.11 | 1.12 | 1.09 | 1.11 | 1.10 | 1.09 | 1.07 | 1.12 | 1.11 |
| Purple | 1.74 | 1.31 | 1.27 | 1.79 | 1.28 | 1.27 | 1.70 | 1.61 | 1.26 | 1.23 |
| Green | 1.63 | 1.33 | 1.31 | 1.68 | 1.33 | 1.33 | 1.67 | 1.64 | 1.36 | 1.30 |
| Cyan | 1.93 | 1.68 | 1.69 | 1.94 | 1.69 | 1.64 | 1.86 | 2.07 | 1.86 | 1.71 |

Images printed on Working Examples 137 to 146 generally demonstrated good image density levels across the HP 940C and EPSON 888 desktop printers. Examples 137, 140 and 143, which did not employ FWA I or CATIONIC RESIN I or II in the Overcoat Layer, had slightly higher image densities than Examples 138, 139, 141, 142, 145 and 146, which did employ FWA I and CATIONIC RESIN I in the Overcoat Layer. Examples 138 and 139, 141 and 142, and 145 and 146 revealed that as the amount of FWA I and CATIONIC RESIN I in the Overcoat Layer increased, image densities decreased. Example 144, which had slightly higher image densities similar to that of Example 143, employed a lower level of CATIONIC RESIN in its Overcoat Layer.

### EXAMPLES 147 to 156

In these examples, the test samples described above were imaged using HP-940c, EPSON 888 and EPSON 1270 narrow format ink jet printers, the image densities of the formed images measured and recorded, and the test samples evaluated for gloss, waterfastness and lightfastness. The results are set forth in Table 7, hereinbelow.

TABLE 7
Summary of Examples 147 to 156

| | | | | | | Sum of Image | | | % | | % | |
|---|---|---|---|---|---|---|---|---|---|---|---|---|
| | | Under- | Over- | | | Densities | | | Waterfastness | | Lightfastness | |
| | Base | coat | Coat | Gloss | | HP | Epson | Epson | HP | Epson | HP | Epson |
| Example | Paper | Layer | Layer | 60° | 85° | 940C | 888 | 1270 | 940C | 888 | 940C | 888 |
| 147 | BP-2 | U-7 | X | 46 | 71 | 12.06 | 14.64 | 12.47 | 106 | 104 | 93 | 98 |
| 148 | BP-2 | U-7 | XII | 46 | 71 | 11.79 | 13.35 | 11.39 | 110 | 103 | 89 | 93 |
| 149 | BP-2 | U-7 | XIII | 45 | 71 | 11.70 | 12.58 | 11.27 | 109 | 103 | 88 | 91 |
| 150 | BP-3 | U-7 | X | 49 | 73 | 11.99 | 14.57 | 12.57 | 107 | 104 | 93 | 95 |
| 151 | BP-3 | U-7 | XII | 44 | 70 | 11.81 | 13.33 | 11.41 | 109 | 103 | 89 | 94 |
| 152 | BP-3 | U-7 | XIII | 46 | 71 | 11.65 | 12.55 | 11.13 | 108 | 103 | 88 | 91 |
| 153 | BP-3 | U-8 | X | 54 | 79 | 12.16 | 14.89 | 12.44 | 105 | 101 | 93 | 98 |
| 154 | BP-3 | U-8 | XI | 54 | 79 | 12.03 | 14.89 | 12.44 | 105 | 105 | 91 | 97 |
| 155 | BP-3 | U-8 | XII | 52 | 82 | 11.93 | 13.36 | 11.68 | 106 | 96 | 86 | 85 |
| 156 | BP-3 | U-8 | XIII | 53 | 77 | 11.70 | 13.45 | 11.24 | 110 | 102 | 92 | 93 |

The data shown in Table 7 demonstrates that gloss levels are affected by the type of base paper and upon the levels of CATIONIC LATEX II present in the undercoat layer. More specifically, Working Examples 147 and 150 and 149 and 152 demonstrate that the use of BP-3 base papers serve to slightly improve gloss levels, while Working Examples 147, 150 and 153, 148, 151 and 155, and 149, 152 and 156 demonstrate that increased levels of CATIONIC LATEX II in the undercoat layer serves to effect significant increases in gloss levels.

### EXAMPLES 157 to 166

In these examples, the test samples described above were imaged using HP-940c and EPSON 888 narrow format ink jet printers and the test samples evaluated for Brightness, Whiteness, ΔE, Visual Gloss, Waterfastness, Image Uniformity, and Star Wheel Defect. The results are set forth in Table 8, hereinbelow.

TABLE 8
Summary of Examples 157 to 166

| | | | | | | | | Visual | | | | Star Wheels |
|---|---|---|---|---|---|---|---|---|---|---|---|---|
| | | Under- | Over- | | | | Visual | Waterfastness | | Imaged Area | | Printing |
| | Base | coat | coat | | | | Gloss | Rating | | Uniformity | | Defect |
| Example | Paper | Layer | Layer | Brightness | Whiteness | ΔE | Rating | HP 940c | Epson 888 | HP 940c | Epson 888 | Epson 888 |
| 157 | BP-2 | U-7 | X | 88.02 | 98.84 | 0.90 | G | G | VG | G | G | VG |
| 158 | BP-2 | U-7 | XII | 93.57 | 120.01 | 6.50 | G | VG | VG | G | G | VG |
| 159 | BP-2 | U-7 | XIII | 94.51 | 121.90 | 6.66 | G | VG | VG | G | G | VG |
| 160 | BP-3 | U-7 | X | 87.67 | 98.33 | 1.10 | G | G | G | G | G | VG |
| 161 | BP-3 | U-7 | XII | 93.69 | 120.14 | 6.26 | G | VG | VG | G | G | VG |
| 162 | BP-3 | U-7 | XIII | 94.82 | 122.62 | 6.41 | G | VG | VG | G | G | VG |
| 163 | BP-3 | U-8 | X | 87.55 | 98.65 | 0.98 | G | G | G | G | G | VG |
| 164 | BP-3 | U-8 | XI | 89.27 | 106.99 | 3.50 | G | G | VG | G | G | VG |
| 165 | BP-3 | U-8 | XII | 92.66 | 119.05 | 6.32 | G | G | VG | G | G | VG |
| 166 | BP-3 | U-8 | XIII | 94.09 | 120.95 | 6.40 | G | VG | VG | G | G | VG |

The data shown in Table 8 again illustrates the combination of properties demonstrated by the glossy ink jet recording material of the present invention. In addition to demonstrating good gloss, excellent waterfastness, imaged area uniformity and lack of star wheels printing defects, the inventive recording material demonstrated good brightness, whiteness and lightfastness. It is noted that the presence of FWA/CATIONIC RESIN in the overcoat ink jet receptive layer may adversely impact upon lightfastness (i.e., higher ΔE values). Nonetheless, higher brightness and whiteness values were achieved than otherwise possible.

### Part C

Commercial ink jet papers, which are identified below, were also tested for comparison purposes.

### COMMERCIAL PAPERS

CP1: HP premium plus photo paper glossy, Part # c6831-60024, Lot # U.S. Pat. No. 962103, made in USA.

CP2: HP Brochure & Flyer paper gloss, two sided glossy, Part # c6817A, Lot # U.S. Pat. No. 04050009, made in USA.

CP3: Epson glossy photo paper, Part # S041649, Lot # Y2BC2F723, made in Japan

CP4: Epson Photo Paper, Part # S041141, Lot # Y1GI0N816, made in Japan

CP5: Kodak premium picture paper heavyweight high gloss, Part # 8245276, Lot # A20111280003, made in Canada.

CP6: Kodak glossy ink jet paper, heavyweight, two sided glossy, Part # 1194646, Lot # 2011 34 2034, made in USA

CP7: Jet Print Photo mult-project photo paper, Part # 17036-0, product of USA & Germany.

CP8: Jet Print Photo premium photo paper, Part # 02744-0, product of Switzerland.

CP9: Jet Print Photo professional photo paper, part # 02728-0, product of Japan.

### EXAMPLES C-1 to C-9

In these examples, the commercial papers identified above were imaged using either an HP-940c, EPSON 888, or EPSON 1270 narrow format ink jet printer and the image densities of the formed images measured and recorded. The results are set forth in Table 9, hereinbelow.

TABLE 9
Summary of Comparative Examples C-1 to C-9

| | Example | | | | | | | | |
|---|---|---|---|---|---|---|---|---|---|
| | C-1 | C-2 | C-3 | C-4 | C-5 | C-6 | C-7 | C-8 | C-9 |
| Com- | CP1 | CP2 | CP3 | CP4 | CP5 | CP6 | CP7 | CP8 | CP9 |
| mer- | | | | | | | | | |
| cial | | | | | | | | | |
| Paper | | | | | | | | | |

Image Densities

| | | | | | | | | | |
|---|---|---|---|---|---|---|---|---|---|
| HP- | | | | | | | | | |
| 940C | | | | | | | | | |
| Black | 2.34 | 1.92 | 1.91 | 1.86 | 1.68 | 1.63 | 2.83 | 1.67 | 2.10 |
| Ma- | 2.41 | 1.8 | 2.19 | 2.08 | 1.90 | 1.87 | 2.53 | 1.75 | 2.15 |
| genta | | | | | | | | | |
| Red | 1.81 | 1.50 | 1.64 | 1.57 | 1.60 | 1.49 | 2.07 | 1.50 | 1.65 |
| Yellow | 1.27 | 1.18 | 1.30 | 1.27 | 1.26 | 1.26 | 1.36 | 1.19 | 1.21 |
| Purple | 2.49 | 1.96 | 2.30 | 2.30 | 1.89 | 2.07 | 2.26 | 1.76 | 2.44 |
| Green | 1.18 | 1.34 | 1.26 | 1.24 | 1.21 | 1.38 | 1.43 | 1.22 | 1.21 |
| Cyan | 0.95 | 1.38 | 1.08 | 1.10 | 1.12 | 1.26 | 1.09 | 1.14 | 1.05 |
| Epson | | | | | | | | | |
| 888 | | | | | | | | | |
| Black | 2.52 | 1.93 | 2.31 | 2.24 | 2.39 | 2.15 | 2.73 | 2.48 | 2.48 |
| Ma- | 2.07 | 1.67 | 1.93 | 1.85 | 1.92 | 1.69 | 2.36 | 2.06 | 1.88 |
| genta | | | | | | | | | |
| Red | 2.08 | 1.66 | 1.90 | 1.81 | 1.79 | 1.66 | 2.26 | 2.10 | 1.79 |
| Yellow | 1.40 | 1.27 | 1.38 | 1.35 | 1.38 | 1.22 | 1.46 | 1.42 | 1.35 |
| Purple | 2.43 | 1.98 | 2.37 | 2.35 | 2.13 | 1.66 | 3.18 | 2.31 | 2.51 |
| Green | 2.33 | 1.84 | 2.06 | 1.97 | 1.90 | 1.26 | 2.66 | 2.35 | 2.24 |
| Cyan | 2.38 | 2.00 | 2.40 | 2.43 | 2.13 | 1.75 | 2.91 | 2.11 | 2.57 |
| Epson | | | | | | | | | |
| 1270 | | | | | | | | | |
| Black | 2.55 | 1.94 | 2.27 | 2.20 | 2.39 | 2.18 | 3.15 | 2.52 | 2.56 |
| Ma- | 1.96 | 1.66 | 1.86 | 1.77 | 1.89 | 1.63 | 2.28 | 2.01 | 1.86 |
| genta | | | | | | | | | |
| Red | 1.96 | 1.65 | 1.83 | 1.73 | 1.82 | 1.60 | 2.28 | 2.04 | 1.80 |
| Yellow | 1.07 | 1.09 | 1.16 | 1.12 | 1.22 | 1.11 | 1.27 | 1.21 | 1.13 |
| Purple | 2.33 | 1.96 | 2.06 | 2.04 | 2.33 | 1.32 | 2.35 | 2.35 | 2.31 |
| Green | 2.22 | 1.85 | 1.82 | 1.76 | 2.13 | 1.25 | 2.92 | 2.28 | 2.33 |
| Cyan | 2.17 | 1.97 | 2.14 | 2.20 | 2.11 | 1.42 | 2.43 | 1.79 | 2.33 |

By way of these Comparative Examples, it can be seen that only three of the commercial papers tested, namely—Comparative Examples C-1, C-7 and C-9, produced images having acceptable image density levels across the three printer platforms. A majority of the remaining commercial papers performed well on the Epson printers, but a marked decline in image densities was observed when these papers were imaged with the HP-940c printer.

### EXAMPLES C-10 to C-18

In these examples, the commercial papers identified above were imaged using either an HP-940c, EPSON 888, or EPSON 1270 narrow format ink jet printer and the image densities of the formed images measured and the sum of the image densities for the colors tested for each paper were added together. The test samples were also evaluated for gloss, waterfastness and lightfastness. The results are set forth in Table 10, hereinbelow.

TABLE 10
Summary of Comparative Examples C-10 to C-18

| | | | | Sum of | | | % | | % | |
|---|---|---|---|---|---|---|---|---|---|---|
| | | | | Image Densities | | | Waterfastness | | Lightfastness | |
| | Commercial | Gloss | | HP | Epson | Epson | HP | Epson | HP | Epson |
| Example | Paper | 60° | 85° | 940C | 888 | 1270 | 940C | 888 | 940C | 888 |
| C-10 | CP1 | 87 | 97 | 12.45 | 15.21 | 14.26 | 87 | 98 | 94 | 99 |
| C-11 | CP2 | 46 | 85 | 11.08 | 12.35 | 12.12 | 88 | 95 | 89 | 95 |
| C-12 | CP3 | 40 | 78 | 11.68 | 14.35 | 13.14 | 105 | 102 | 96 | 99 |
| C-13 | CP4 | 44 | 81 | 11.42 | 14.00 | 12.82 | 105 | 103 | 96 | 98 |
| C-14 | CP5 | 76 | 88 | 10.66 | 13.64 | 13.89 | 111 | 98 | 96 | 99 |
| C-15 | CP6 | 49 | 74 | 10.96 | 11.39 | 10.51 | 92 | 100 | 84 | 87 |
| C-16 | CP7 | 72 | 83 | 13.57 | 17.56 | 16.68 | 59 | 74 | 94 | 94 |
| C-17 | CP8 | 80 | 86 | 10.23 | 14.83 | 14.20 | 101 | 52 | 99 | 88 |
| C-18 | CP9 | 34 | 78 | 11.81 | 14.82 | 14.32 | 105 | 107 | 95 | 102 |

By way of these Comparative Examples, it has been shown that while Comparative Examples C-1, C-7 and C-9 produced images having acceptable image density levels across the HP 940c, EPSON 888 and EPSON 1270 printer platforms, these papers failed to demonstrate the combination of properties demonstrated by the glossy ink jet recording material of the present invention. In particular, images formed on Comparative. Examples C-1 and C-7 had relatively poor waterfastness, while 60° gloss levels were low for Comparative Example C-9.

### EXAMPLES C-19 to C-27

In these examples, the commercial papers identified above were imaged using either an HP-940c, EPSON 888, or EPSON 1270 narrow format ink jet printer and the imaged papers evaluated for brightness, whiteness, ΔE, Visual Gloss, Visual Waterfastness, Imaged Area Uniformity, and Star Wheels Printing Defect. The results are set forth in Table 11, hereinbelow.

TABLE 11
Summary of Comparative Examples C-19 to C-27

| | | | | | | Visual | | Imaged Area | | |
|---|---|---|---|---|---|---|---|---|---|---|
| | | | | | | Waterfastness | | Uniformity | | |
| | Commercial | | | | Visual | HP | Epson | HP | Epson | Star Wheels |
| Example | Paper | Brightness | Whiteness | ΔE | Gloss | 940c | 888 | 940c | 888 | Epson 888 |
| C-19 | CP1 | 89.4 | 102.1 | 3.45 | G | P | P | G | P | P |
| C-20 | CP2 | 85.8 | 89.6 | 2.19 | F | P | P | F | P | F |
| C-21 | CP3 | 93.7 | 104.5 | 3.06 | G | G | G | G | G | G |
| C-22 | CP4 | 92.4 | 100.5 | 2.74 | G | G | G | G | G | G |
| C-23 | CP5 | 91.7 | 113.0 | 2.50 | G | P | F | F | G | VG |
| C-24 | CP6 | 90.2 | 111.9 | 5.59 | F | F | F | F | F | VG |
| C-25 | CP7 | 87.3 | 97.8 | 5.82 | G | P | P | G | G | P |
| C-26 | CP8 | 88.2 | 97.7 | 1.73 | G | P | P | F | G | VG |
| C-27 | CP9 | 94.0 | 110.6 | 1.50 | G | VG | VG | G | G | VG |

Comparative Examples C-19 to C-27 generally demonstrated lower levels of whiteness, while Comparative Examples C-19, C-20, C-23 and C-24 to C-26 did not perform well in the areas of Visual Gloss, Visual Waterfastness, Imaged Area Uniformity and/or Star Wheels Defect.

While various embodiments of the present invention have been described above, it should be understood that they have been presented by way of example only, and not limitation. Thus, the breadth and scope of the present invention should not be limited by any of the exemplary embodiments.

Having thus described the invention, what is claimed is:

1. A coating formulation for use in preparing a glossy ink jet recording material, which comprises:
(a) from about 75 to about 98% by weight, based on the total dry weight of the coating formulation, of a pigment composition comprising:
(i) from about 0 to about 20% by weight, based on the total dry weight of the pigment composition, of a silica pigment; and
(ii) from about 100 to about 80% by weight, based on the total dry weight of the pigment composition, of fumed metallic oxide particles,
wherein, the sum of the pigment composition components total 100% by dry weight, and
(b) from about 0.5 to about 25% by weight, based on the total dry weight of the coating formulation, of a binder selected from the group of polyurethane, polyester, styrene acrylic and polyvinyl alcohol resins and blends thereof,
wherein, the sum of the coating formulation components total 100% by dry weight, and
wherein the ratio of binder to pigment composition ranges from about 1:100 to about 1:4.

2. The coating formulation of claim 1, wherein the pigment composition is present in the coating formulation in an amount ranging from about 80 to about 96% by weight, and wherein the binder is present in the coating formulation in an amount ranging from about 2 to about 15% by weight.

3. The coating formulation of claim 1, wherein the silica pigment is selected from the group of amorphous silicas, colloidal silicas, fumed silicas, precipitated silicas, silica-gel particles, and blends thereof.

4. The coating formulation of claim 3, wherein the silica pigment is selected from the group of amorphous silicas and fumed silicas that have a primary particle size ranging from about 1 to about 300 nanometers.

5. The coating formulation of claim 3, wherein the silica pigment is selected from the group of silica-gel particles that have a primary particle size ranging from about 0.05 to about 0.5 microns, and an average pore volume ranging from about 0.1 to about 1.0 grams per cubic centimeter.

6. The coating formulation of claim 1, wherein the silica pigment is present in the pigment composition in an amount ranging from about 1 to about 15% by weight.

7. The coating formulation of claim 1, wherein the fumed metallic oxide particles are selected from the group of alumina, titania, antimony(III) oxide, germanium(IV) oxide, tungsten(VI) oxide, and blends thereof.

8. The coating formulation of claim 7, wherein the fumed metallic oxide particles are fumed alumina particles that have a primary particle size ranging from about 1 to about 100 nanometers and that are aggregated to a size ranging from about 50 to about 400 nanometers.

9. The coating formulation of claim 1, wherein the fumed metallic oxide particles are present in the pigment composition in an amount ranging from about 99 to about 85% by weight.

10. The coating formulation of claim 1, wherein the binder is selected from the group of polyurethane resins, styrene acrylic resins, and blends thereof.

11. The coating formulation of claim 1, wherein the ratio of binder to pigment composition ranges from about 1:60 to about 1:7.

12. The coating formulation of claim 11, wherein the ratio of binder to pigment composition ranges from about 1:40 to about 1:10.

13. The coating formulation of claim 1, which further comprises from about 1 to about 20% by weight, based on the total dry weight of the coating formulation, of a synthetic pigment selected from the group of polyacrylic resins and polystyrene-acrylic resins having a T_{g} of at least 80° C. and a primary particle size ranging from about 0.05 to about 0.5 micron.

14. The coating formulation of claim 13, wherein the synthetic pigment is a cationically charged synthetic pigment.

15. The coating formulation of claim 1, which further comprises from about 0.05 to about 1.0% by weight, based on the total dry weight of the coating formulation, of a fluorescent optical brightener selected from the group of cationic pyrazoline, cationic benzimidazole, benzoxazole derivatives, and blends thereof.

16. A coating formulation for use in preparing a glossy ink jet recording material, which has a cationic charge and which comprises:
(a) from about 80 to about 96% by weight, based on the total dry weight of the coating formulation, of a pigment composition comprising:
(i) from about 1 to about 15% by weight, based on the total dry weight of the pigment composition, of a silica pigment selected from the group of amorphous silica pigments, fumed silica pigments, and blends thereof; and
(ii) from about 99 to about 85% by weight, based on the total dry weight of the pigment composition, of fumed alumina particles,
wherein, the sum of the pigment composition components total 100% by dry weight, and
(b) from about 2 to about 15% by weight, based on the total dry weight of the coating formulation, of a binder selected from the group of polyurethane resins, styrene acrylic resins, and blends thereof,
wherein the ratio of binder to pigment composition ranges from about 1:60 to about 1:7,
(c) from about 1 to about 20% by weight, based on the total dry weight of the coating formulation, of a polystyrene-acrylic or polyacrylic synthetic pigment, and
(d) from about 0.05 to about 1.0% by weight, based on the total dry weight of the coating formulation, of a cationic fluorescent optical brightener,
wherein, the sum of the coating formulation components total 100% by dry weight.

17. A glossy ink jet recording material, which comprises:
(a) a substrate having an upper surface and a lower surface,
(b) at least one undercoat ink jet receptive layer located on the upper surface of the substrate, wherein the undercoat layer is prepared using a coating formulation comprising:
(i) from about 75 to about 98% by weight, based on the total dry weight of the coating formulation, of a pigment composition comprising:
a. from about 0 to about 20% by weight, based on the total dry weight of the pigment composition, of a silica pigment; and
b. from about 100 to about 80% by weight, based on the total dry weight of the pigment composition, of fumed metallic oxide particles,
wherein, the sum of the pigment composition components total 100% by dry weight, and
(ii) from about 0.5 to about 25% by weight, based on the total dry weight of the coating formulation, of a binder selected from the group of polyurethane, polyester, styrene acrylic and polyvinyl alcohol resins and blends thereof,
wherein, the sum of the coating formulation components total 100% by dry weight, and
wherein the ratio of binder to pigment composition ranges from about 1:100 to about 1:4,
(c) optionally, at least one overcoat ink jet receptive layer located on the undercoat layer, wherein the overcoat layer is prepared using a coating formulation comprising:
(i) from about 70 to about 99% by wt., based on the total dry weight of the coating formulation, of a pigment composition comprising:
a. greater than about 20 to about 99% by wt., based on the total dry weight of the pigment composition, of a silica pigment; and
b. less than about 80 to about 1% by wt., based on the total dry weight of the pigment composition, of fumed metallic oxide particles,
wherein, the sum of the pigment composition components total 100% by dry wt., and
(ii) from about 0.5 to about 25% by wt., based on the total dry weight of the coating formulation, of a binder selected from the group of polyurethane, polyester, styrene acrylic and polyvinyl alcohol resins and blends thereof,
wherein, the coating formulation components total 100% by dry weight,
wherein, the ratio of fumed metallic oxide particles to silica pigment ranges from about 1:100 to about 4:1, and
wherein, the ratio of binder to pigment composition ranges from about 1:200 to about 1:4, and
(d) optionally, one or more anti-curl layers located on the lower surface or backside of the substrate.

18. The glossy ink jet recording material of claim 17, which exhibits a high gloss finish of at least about 35° reflection on its surface.

19. The glossy ink jet recording material of claim 18, which exhibits a high gloss finish of at least about 45° reflection on its surface.

20. The glossy ink jet recording material of claim 19, which exhibits a high gloss finish of at least about 55° reflection on its surface.

21. The glossy ink jet recording material of claim 17, wherein the substrate exhibits a Bekk smoothness of at least about 20 seconds, determined in accordance with TAPPI Method No. T-479 cm-99.

22. The glossy ink jet recording material of claim 17, which further comprises one or more smoothing layers.

23. The glossy ink jet recording material of claim 22, wherein the smoothing layer(s) is prepared using a pigment composition comprising, as main ingredients, silica and calcium carbonate pigments.

24. The glossy ink jet recording material of claim 23, which is acid free.

25. The glossy ink jet recording material of claim 17, wherein the at least one undercoat ink jet receptive layer is prepared using a coating formulation comprising:
(a) from about 80 to about 96% by weight, based on the total dry weight of the coating formulation, of a pigment composition comprising:
(i) from about 1 to about 15% by weight, based on the total dry weight of the pigment composition, of a silica pigment selected from the group of amorphous silica pigments, fumed silica pigments, and blends thereof; and
(ii) from about 99 to about 85% by weight, based on the total dry weight of the pigment composition, of fumed alumina particles,
wherein, the sum of the pigment composition components total 100% by dry weight, and
(b) from about 2 to about 15% by weight, based on the total dry weight of the coating formulation, of a binder selected from the group of polyurethane resins, styrene acrylic resins, and blends thereof,
wherein the ratio of binder to pigment composition ranges from about 1:60 to about 1:7,
(c) from about 1 to about 20% by weight, based on the total dry weight of the coating formulation, of a polystyrene-acrylic or polyacrylic synthetic pigment, and
(d) from about 0.05 to about 1.0% by weight, based on the total dry weight of the coating formulation, of a cationic fluorescent optical brightener,
wherein, the sum of the coating formulation components total 100% by dry weight.

26. The glossy ink jet recording material of claim 17, which comprises at least one overcoat ink jet receptive layer.

27. The glossy ink jet recording material of claim 26, wherein the silica pigment of the pigment composition of the coating formulation used to prepare the overcoat ink jet receptive layer(s) is an amorphous silica pigment and is present in the pigment composition in an amount ranging from about 50 to about 98% by weight.

28. The glossy ink jet recording material of claim 26, wherein the fumed metal oxide particles of the pigment composition of the coating formulation used to prepare the overcoat ink jet receptive layer(s) are fumed alumina particles and are present in the pigment composition in an amount ranging from about 50 to about 2% by weight.

29. The glossy ink jet recording material of claim 26, wherein the binder of the coating formulation used to prepare the overcoat ink jet receptive layer(s) is selected from the group of polyurethane resins, styrene acrylic resins, and blends thereof, and is present in the coating formulation in an amount ranging from about 1 to about 10% by weight.

30. The glossy ink jet recording material of claim 26, wherein the ratio of fumed metallic oxide particles to silica pigment in the coating formulation used to prepare the overcoat ink jet receptive layer(s) ranges from about 1:50 to about 1:1.

31. The glossy ink jet recording material of claim 30, wherein the ratio of fumed metallic oxide particles to silica pigment in the coating formulation used to prepare the overcoat ink jet receptive layer(s) ranges from about 1:40 to about 1:2.

32. The glossy ink jet recording material of claim 26, wherein the ratio of binder to pigment composition in the coating formulation used to prepare the overcoat ink jet receptive layer(s) ranges from about 1:100 to about 1:7.

33. The glossy ink jet recording material of claim 32, wherein the ratio of binder to pigment composition in the coating formulation used to prepare the overcoat ink jet receptive layer(s) ranges from about 1:60 to about 1:10.

34. The glossy ink jet recording material of claim 26, wherein the coating formulation used to prepare the overcoat ink jet receptive layer(s) further comprises from about 1 to about 20% by weight, based on the total weight of the coating formulation, of a synthetic pigment selected from the group of polyacrylic resins and polystyrene-acrylic resins having a T_{g} of at least 80° C., and a primary particle size ranging from about 0.05 to about 0.5 micron.

35. The glossy ink jet recording material of claim 34, wherein the synthetic pigment is a cationically charged synthetic pigment.

36. The glossy ink jet recording material of claim 26, wherein the coating formulation used to prepare the overcoat ink jet receptive layer(s) further comprises from about 0.05 to about 1.0% by weight, based on the total dry weight of the coating formulation, of a fluorescent optical brightener selected from the group of disulfonated, tetrasulfonated and hexasulfonated stilbene, cationic pyrazoline, cationic benzimidazole, benzoxazole derivatives, and blends thereof.

37. The glossy ink jet recording material of claim 36, wherein the fluorescent optical brightener is a cationic pyrazoline fluorescent optical brightener.

38. The glossy ink jet recording material of claim 36, wherein the fluorescent optical brightener is an anionic fluorescent optical brightener stabilized with one or more cationic resins.

39. The glossy ink jet recording material of claim 38, wherein the cationic resin stabilized anionic fluorescent optical brightener is a polydiallyldimethyl ammonium chloride cationic resin stabilized anionic stilbene fluorescent optical brightener.

40. The glossy ink jet recording material of claim 26, wherein the coating formulation used to prepare the overcoat ink jet receptive layer(s) has a cationic charge and comprises:
(a) from about 80 to about 98% by weight, based on the total dry weight of the coating formulation, of a pigment composition comprising:
(i) from about 50 to about 98% by weight, based on the total dry weight of the pigment composition, of an amorphous silica pigment; and
(ii) from about 50 to about 2% by weight, based on the total dry weight of the pigment composition, of a fumed alumina pigment,
(b) from about 1 to about 10% by weight, based on the total dry weight of the coating formulation, of a binder selected from the group of polyurethane resins, styrene acrylic copolymers and blends thereof,
wherein the ratio of fumed alumina pigment to amorphous silica pigment ranges from about 1:50 to about 1:1, and
wherein the ratio of binder to pigment composition ranges from about 1:100 to about 1:7; and
(c) from about 1 to about 20% by weight, based on the total dry weight of the coating formulation, of a synthetic pigment selected from the group of polyacrylic resins, polystyrene-acrylic resins and blends thereof, and
(d) from about 0.05 to about 1.0% by weight, based on the total dry weight of the coating formulation, of a polydiallyidimethyl ammonium chloride cationic resin stabilized anionic stilbene fluorescent optical brightener,
wherein the dry weight ratio of anionic stilbene fluorescent optical brightener to cationic resin ranges from about 1:10 to about 2:1, and
wherein, the coating formulation components total 100% by dry weight.
